(19) United States
(12) Patent Application Publication
(10) Pub. No.: US 2026/0333267 A1
(43) Pub. Date: Oct. 22, 2026

(54) USER EQUIPMENT POSITIONING WITH LIMITED OR NO CONNECTIVITY TO SATELLITE SYSTEMS

(71) Applicant: Lenovo (United States) Inc., Morrisville, NC (US)

(72) Inventors: Robin Rajan Thomas, Bad Nauheim (DE); Sher Ali Cheema, Ilmenau (DE); Khaled Nafez Rauf Ardah, Ilmenau (DE)

(73) Assignee: Lenovo (United States) Inc., Morrisville, NC (US)

(21) Appl. No.: 19/382,213

(22) Filed: Nov. 6, 2025

(51) Int. Cl. H04W 56/00; G01S 19/48

(52) U.S. Cl. CPC H04W 56/0045; G01S 19/48

(57) ABSTRACT

Various aspects of the present disclosure relate to user equipment (UE) positioning with limited or no connectivity to satellite systems. An apparatus, such as a UE, may receive positioning assistance data (AD) for uplink (UL) time and frequency synchronization. The UE may determine a location of the UE using a positioning method if global navigation satellite system (GNSS) connectivity is unavailable. The UE may determine timing pre-compensation values and frequency pre-compensation values for UL transmission based on the determined location of the UE.

### TECHNICAL FIELD

The present disclosure relates to wireless communications, and more specifically to managing (e.g., transmitting, receiving, determining, etc.) positioning of user equipment (UE) with limited or no connectivity to satellite-based wireless communications systems (e.g., global navigation satellite systems (GNSS)).

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The apparatuses (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive positioning assistance data (AD) for uplink (UL) time and frequency synchronization; determine a location of the UE using a positioning method if global navigation satellite system (GNSS) connectivity is unavailable; and determine timing pre-compensation values and frequency pre-compensation values for UL transmission based on the determined location of the UE.

A processor (e.g., a standalone processor chipset, or a component of the UE) for wireless communication is described. The processor may be configured to, capable of, or operable to perform one or more operations as described herein. For example, the processor may be configured to, capable of, or operable to receive positioning AD for UL time and frequency synchronization; determine a location of the UE using a positioning method if GNSS connectivity is unavailable; and determine timing pre-compensation values and frequency pre-compensation values for UL transmission based on the determined location of the UE.

A method performed or performable by a UE for wireless communication is described. The method may include receiving positioning AD for UL time and frequency synchronization; determining a location of the UE using a positioning method if GNSS connectivity is unavailable; and determining timing pre-compensation values and frequency pre-compensation values for UL transmission based on the determined location of the UE.

In some implementations, the positioning method is one of one or more non-GNSS positioning methods, the UE, the processor, and the method may further be configured to, capable of, or operable to determine that the GNSS connectivity is unavailable, and transmit a request for the positioning AD associated with one or more of the non-GNSS positioning methods.

In some implementations, the UE, the processor, and the method may further be configured to, capable of, or operable to determine that the GNSS connectivity is unavailable due to a system outage or a signal disruption, or due to GNSS accuracy failing to meet an accuracy threshold for pre-compensation determination, and one of: determine and transmit an indication of the system outage or the signal disruption over a period of time; or determine and transmit the indication that the system outage or the signal disruption is temporary or permanent.

In some implementations of the UE, the processor, and the method described herein, the positioning AD of the one or more non-GNSS positioning methods is radio access technology (RAT)-dependent positioning AD or RAT-independent positioning AD; and the positioning AD comprises one or more of observed time difference of arrival (OTDOA) positioning AD, barometric positioning AD, terrestrial beacon system (TBS) assistance data, new radio (NR) downlink time difference of arrival (DL-TDOA) positioning AD, downlink angle of departure (DL-AoD) positioning AD, on-demand downlink positioning reference signal (DL-PRS) configurations, integrity assistance data for NR positioning methods, or sidelink (SL) positioning AD.

In some implementations of the UE, the processor, and the method described herein, the positioning AD includes at least DL-PRS time-frequency information for computing the determined location of the UE; and the DL-PRS time-frequency information comprises bandwidth, a number of physical resource blocks (PRBs), a number of symbols, a comb size, a muting pattern, a repetition configuration, a slot offset, or a resource element offset.

In some implementations, the UE, the processor, and the method may further be configured to, capable of, or operable to utilize one or more of long term evolution (LTE) positioning protocol (LPP) or mobile originated location request (MO-LR) signaling framework for transmission and/or reception of the positioning AD.

In some implementations of the UE, the processor, and the method described herein, the request for the positioning AD of the one or more non-GNSS positioning methods and the determined location comprises one or more of: a first indication of horizontal positioning accuracy, uncertainty, or confidence; or a second indication of vertical positioning accuracy, uncertainty, or confidence.

In some implementations, the UE, the processor, and the method may further be configured to, capable of, or operable to transmit an on-demand request for the positioning AD associated with at least one different non-GNSS positioning method if a positioning accuracy requirement of the determined location of the UE is not met.

In some implementations, the UE, the processor, and the method may further be configured to, capable of, or operable to receive the positioning AD in one or more of system information block 1 (SIB 1), SIB 19, or a SIB established for non-terrestrial network (NTN) GNSS-free operation.

In some implementations of the UE, the processor, and the method described herein, the GNSS connectivity being unavailable triggers one or more of UE-initiated positioning procedures or network (NW)-initiated positioning procedures.

In some implementations of the UE, the processor, and the method described herein, the timing pre-compensation values include a UE-specific timing advance, and the frequency pre-compensation values include a doppler compensation or a doppler shift.

In some implementations of the UE, the processor, and the method described herein, the positioning AD comprises information to enable the UE to derive its own location, and the positioning AD is configured for aperiodic transmission or periodic transmission.

An NE (e.g., a base station) for wireless communication is described. The NE may be configured to, capable of, or operable to perform one or more operations as described herein. For example, the NE may be configured to, capable of, or operable to transmit positioning AD for UL time and frequency synchronization by a UE; receive a request for the positioning AD associated with one or more non-GNSS positioning methods if GNSS connectivity is unavailable; and transmit the positioning AD in one or more of SIB 1, SIB 19, or a SIB established for NTN GNSS-free operation.

A processor (e.g., a standalone processor chipset, or a component of an NE) for wireless communication is described. The processor may be configured to, capable of, or operable to perform one or more operations as described herein. For example, the processor may be configured to, capable of, or operable to transmit positioning AD for UL time and frequency synchronization by a UE; receive a request for the positioning AD associated with one or more non-GNSS positioning methods if GNSS connectivity is unavailable; and transmit the positioning AD in one or more of SIB 1, SIB 19, or a SIB established for NTN GNSS-free operation.

A method performed or performable by an NE (e.g., a base station) for wireless communication is described. The method may include transmitting positioning AD for UL time and frequency synchronization by a UE; receiving a request for the positioning AD associated with one or more non-GNSS positioning methods if GNSS connectivity is unavailable; and transmitting the positioning AD in one or more of SIB 1, SIB 19, or a SIB established for NTN GNSS-free operation.

### BRIEF DESCRIPTION OF THE DRAWINGS

FIG. 1 illustrates an example of a wireless communications system in accordance with aspects of the present disclosure.

FIG. 2 illustrates an example of a timing relationship for a collocated gNB and NTN gateway, in accordance with aspects of the present disclosure.

FIG. 3 illustrates an example information element (IE) for NTN configuration, in accordance with aspects of the present disclosure.

FIG. 4 illustrates an example process as a signaling diagram for UE positioning AD, in accordance with aspects of the present disclosure.

FIG. 5 illustrates an example another example process as a signaling diagram for UE positioning AD, in accordance with aspects of the present disclosure.

FIG. 6 illustrates an example process as a signaling diagram for implementations of request and response information exchange for NTN-specific parameters related to a determination of UE-based RAT-dependent and/or RAT-independent positioning, in accordance with aspects of the present disclosure.

FIG. 7 illustrates an example process as a signaling diagram for implementations of request and response information exchange related to NW-initiated UE-based RAT-dependent and/or RAT-independent positioning based on loss of GNSS connectivity, in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of an NE in accordance with aspects of the present disclosure.

FIG. 11 illustrates an example of a flowchart of a method performed by a UE in accordance with aspects of the present disclosure.

FIG. 12 illustrates an example of a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. A UE may use GNSS coordinates to determine its position and/or location, which may then be utilized to pre-compensate for time and frequency shift or offsets. To access NR NTN and/or Internet-of-things (IoT) NTN, the UE may require GNSS capabilities and an active GNSS connection. In NR-NTN, an open loop timing adjustment technique may be used for transparent payload NTN architecture, in which the timing advance (TA) is partitioned into a common TA (corresponding to feeder link round trip time (RTT)) and user-specific TA (corresponding to a service link two-way transmission delay). To estimate the user-specific TA, the UE may acquire the position of the serving satellite, which is supplied by the network (e.g., an NE), as well as its own location as determined by GNSS. Because non-geostationary orbit (NGSO) satellites are continuously moving, the UE may continuously update the TA and frequency pre-compensation while in a linked mode. To gain NTN access, the UE may maintain an active GNSS connection during its connectivity duration.

Although GNSS provides accurate location and time reference, there may be several occasions or scenarios in which GNSS signals are unavailable for a period of time. For example, GNSS signals may be unavailable during a period of service interruption, or may be jammed or spoofed, resulting in inaccurate UE positioning and subsequent denial of NTN connectivity. Further, an incorrect UE location may cause an erroneous user-specific TA, thereby precluding UL communication for the UE. The unavailability of GNSS may also simultaneously impact a large group of UEs within a serving cell for a period of time. Additionally, NTN service for a UE may become degraded due to reduced GNSS location estimates and reduced positioning accuracy, which may occur for various reasons, including a low GNSS link budget, an insufficient number of available satellites, an unfavorable position or location of a UE, or environmental conditions (e.g., GNSS signal blockage, or the like) in which a UE is located.

Aspects of the present disclosure are described in the context of a wireless communications system. As described herein, a UE may determine its own position in response to (e.g., if, when) GNSS connectivity being unavailable, in conjunction with the 3GPP positioning framework while the UE is in a connected mode (also referred to as RRC_CONNECTED) or an idle mode (also referred to as RRC_IDLE). To provide alternatives to GNSS-based positioning, the wireless communications system (e.g., NE) may configure other positioning methods, such as downlink (DL)-TDoA or DL-AoD, to reduce time and frequency uncertainty or ambiguity in the event of a loss of GNSS connectivity. A reduction or denial of NR NTN service to UEs that are connected, or in RRC_CONNECTED, due to temporary unavailability and/or inaccuracy of GNSS positioning, may have a significant impact on overall NTN system connectivity and performance, as well as on the user experience of NTN-capable UEs. Therefore, a UE may rely on one or more non-GNSS positioning methods for location estimation of the UE, where such positioning methods are decoupled from GNSS-based solutions.

By performing the described techniques, a UE in a wireless communications system may perform remedial action to obtain positioning AD when either the UE or the network (e.g., NE) detects a disruption or loss of GNSS connectivity. The network can promptly provide positioning AD and/or the UE can receive the AD from the network, enabling the UE to accurately determine its own position even during GNSS outages. Additionally, the described techniques may provide an improved TA accuracy with network-configured reporting and threshold monitoring to enable precise TA calculations, even when GNSS connectivity is temporarily unavailable, supporting reliable UL synchronization for UEs in both idle and connected modes. Additionally, the described techniques may provide increased system robustness and flexibility, given the ability to support various options for a UE to request and receive positioning AD, while maintaining the same TA accuracy, or improved accuracy, as that of GNSS, even during a loss of GNSS connectivity.

Aspects of the described techniques address the critical issue of maintaining accurate positioning and uplink synchronization for UEs when GNSS connectivity is disrupted or unavailable. The described techniques solve the problem of the network and a UE lacking a mechanism to detect and respond to GNSS outages, which can result in degraded positioning accuracy, and hence TA accuracy and compromised system reliability. By enabling timely detection of GNSS outages and unavailable GNSS connectivity, and by triggering or initiating alternate positioning procedures, these solutions ensure continued network performance and service quality.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

Additional aspects of the present disclosure are described in the context of component diagrams, process flows, method flowcharts, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein, but is to be accorded the broadest scope consistent with the principles and novel features disclosed herein.

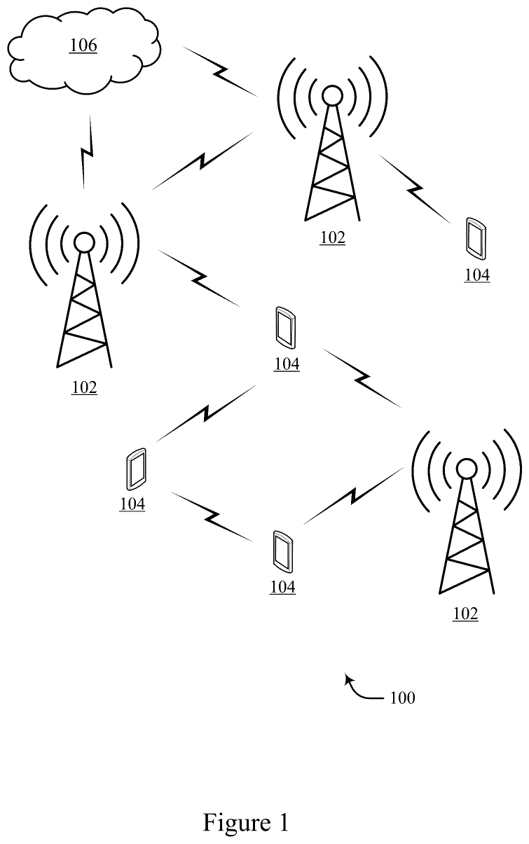

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, infrastructure, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support UE positioning with limited or no connectivity to satellite systems by providing that a UE 104 may determine its own position, in conjunction with the 3GPP positioning framework in a RRC_CONNECTED or RRC_IDLE state of the UE. For alternatives to GNSS reliance, the network (e.g., an NE 104, gNB, LMF) may configure other positioning methods, such as DL-TDoA or DL-AoD, to reduce the time and frequency uncertainty or ambiguity in the event of a loss of GNSS connectivity. The reduction or denial of NR NTN service to UEs that are already connected or in a RRC_CONNECTED state, due to temporary unavailability and/or inaccuracy of GNSS positioning, may have a more severe impact on the overall NTN system connectivity and performance, while at the same time impact the user experience of NTN-capable UEs. Therefore, a UE 104 may rely on one or more other non-GNSS positioning methods for location estimation of the UE, which is decoupled from GNSS solutions.

Although GNSS offers accurate location and time reference, there may be several occasions or scenarios in which GNSS signals are unavailable for a period of time. For example, GNSS signals may be unavailable due to being out of service, jammed, or spoofed, resulting in inaccurate UE positioning and subsequent denial of NTN connectivity. Further, the user-specific TA caused by an incorrect UE location may preclude UL communication. The circumstances of GNSS being unavailable may scale and simultaneously impact a large group of UEs within a serving cell for a period of time. Furthermore, there may be times when the NTN service for a UE is degraded due to relatively reduced GNSS location estimates (e.g., accuracy reduced to 500m or 1 km), which may occur for a variety of reasons, including a low GNSS link budget, the unavailability of a required number of satellites, the position or location of a UE (e.g., in a pocket, bag, etc.), or the environment in which a UE is located (e.g., in an urban setting, on a street, through a canyon, etc.).

By performing the described techniques, a UE 104 in the wireless communications system 100 may take remedial action to obtain positioning AD when either the UE or the network (e.g., an NE 104) detects a disruption or loss of GNSS connectivity. The network can promptly provide positioning AD and/or the UE 104 can receive such data, enabling the UE to accurately determine its own position even during GNSS outages. Additionally, the described techniques may provide an improved TA accuracy with network-configured reporting and threshold monitoring for precise TA calculations, even when GNSS connectivity is temporarily unavailable, supporting reliable UL synchronization for UEs in both idle and connected states. Additionally, the described techniques may provide increased system robustness and flexibility, given the ability to support various options for a UE to request and receive positioning AD, while maintaining the same TA accuracy, or improved accuracy, as that of GNSS, even during a loss of GNSS connectivity.

An NE 102 and/or a UE 104 may transmit signals using one or more resources, such as resources in the time domain, frequency domain, and/or spatial domain. According to implementations, one or more of the NEs 102 and the UEs 104 are operable to implement various aspects of the techniques described with reference to the present disclosure. For example, a UE 104 receives positioning AD for UL time and frequency synchronization, determines a location of the UE using a positioning method if GNSS connectivity is unavailable, and the UE 104 determines timing pre-compensation values and frequency pre-compensation values for UL transmission based on the determined location of the UE. An NE 102 (e.g., a base station, gNB) transmits positioning AD for UL time and frequency synchronization by a UE 104, receives a request for the positioning AD associated with one or more non-GNSS positioning methods if GNSS connectivity is unavailable, and the NE 102 transmits the positioning AD in one or more of SIB 1, SIB 19, or a SIB established for NTN GNSS-free operation.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to timing adjustments in NTN, time and frequency synchronization in NTN is described. For scheduling and timing, DL and UL are frame aligned at the uplink time synchronization reference point (RP) with an offset given by N_{TA,offset}. To accommodate the propagation delay in NTNs, several timing relationships are enhanced by a Common Timing Advance (Common TA) and two offsets K_{offset} and k_{mac}. Common TA is a configured timing offset that is equal to the RTT between the RP and the NTN payload. The K_{offset} is a configured scheduling offset that needs to be larger or equal to the sum of the service link RTT and the Common TA. The k_{mac} is a configured offset that is approximately equal to the RTT between the RP and the gNB. The scheduling offset K_{offset} is used to allow the UE sufficient processing time between a downlink reception and an uplink transmission. The offset k_{mac} is used to delay the application of a downlink configuration indicated by a medium access control control element (MAC CE) command on physical downlink shared channel (PDSCH), and in estimation of UE-gNB RTT. It may be provided by the network when downlink and uplink frame timing are not aligned at gNB. The k_{mac} is also used in the random access procedure to determine the start time of random access response (RAR) window or MsgB window after a Msg1 or MsgA transmission.

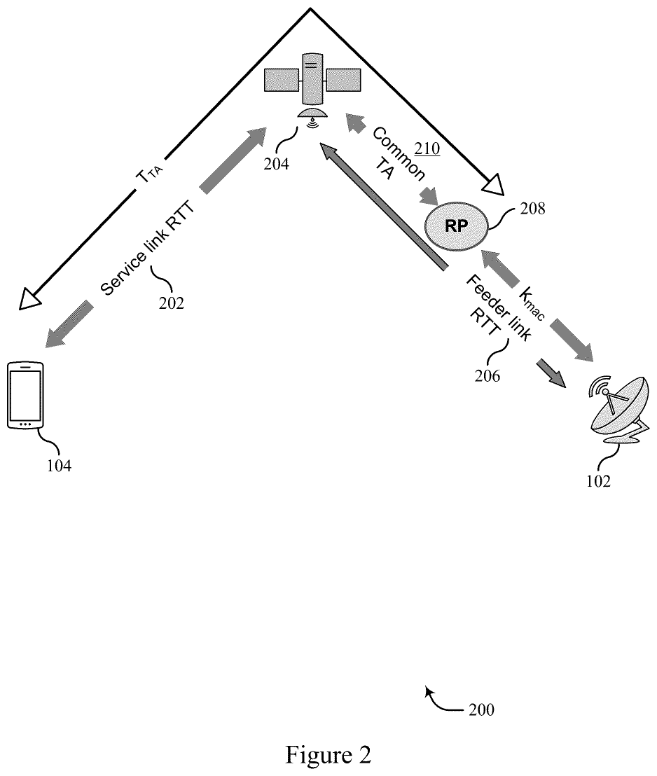

FIG. 2 illustrates an example 200 of a timing relationship for a collocated gNB and NTN gateway in accordance with aspects of the present disclosure. This example 200 illustrates a service link RTT 202 between an NTN gateway 204 and a UE 104, a feeder link RTT 206 between the NTN gateway 204 and an NE 102 (e.g., a gNB), a RP 208, and a common TA 210, as well as k_{mac} and T_{TA}.

The network may configure the hybrid automatic repeat request (HARQ) operation. For downlink, HARQ feedback can be enabled or disabled per HARQ process. Disabling HARQ feedback allows scheduling a HARQ process before one HARQ RTT has elapsed since last scheduled. For uplink, HARQ mode (i.e. HARQ mode A or HARQ mode B) can be configured per HARQ process. HARQ mode B allows scheduling a HARQ process before one HARQ RTT has elapsed since last scheduled. Note that for the HARQ processes configured with HARQ feedback enabled or disabled, it is up to network implementation to ensure a proper configuration of HARQ feedback (e.g., either all enabled or all disabled) for HARQ processes used by an semi-persistent scheduling (SPS) configuration. For the HARQ processes configured with HARQ mode, it is up to network implementation to ensure a proper configuration of HARQ mode (e.g., either all HARQ mode A or all HARQ mode B) for HARQ processes used by a cell group (CG) configuration.

With reference to timing advance and frequency per-compensation, for the serving cell, the network broadcasts valid ephemeris information and common TA parameters. The UE shall have valid GNSS position as well as ephemeris and common TA before connecting to an NTN cell. To achieve synchronization, before and during connection to an NTN cell, the UE shall compute the RTT between UE and the RP based on the GNSS position, the ephemeris, and the common TA parameters, and autonomously pre-compensate the T_{TA} for the RTT between the UE and the RP, as illustrated in the example 200. The UE shall compute the frequency Doppler shift of the service link, and autonomously pre-compensate for it in the uplink transmissions, by considering UE position and the ephemeris. If the UE does not have a valid GNSS position and/or valid ephemeris and common TA, it shall not transmit until both are regained. In connected mode, the UE shall be able to continuously update the TA and frequency pre-compensation. The UE may be configured to report TA during random access procedures or in connected mode. In connected mode, event-triggered reporting of the TA is supported. While the pre-compensation of the instantaneous Doppler shift experienced on the service link is to be performed by the UE, the management of Doppler shift experienced over the feeder link and transponder frequency error is left to the network implementation.

With reference to a transmission timing adjustments procedure for TN and NTN, a UE can be provided a value N_{TA,offset} of a timing advance offset for a serving cell by n-TimingAdvanceOffset for the serving cell. If the UE is not provided n-TimingAdvanceOffset for a serving cell, the UE determines a default value N_{TA,offset} of the timing advance offset for the serving cell. If a UE is configured with two UL carriers for a serving cell, a same timing advance offset value N_{TA,offset} applies to both carriers. Upon reception of a timing advance command for a timing advance group (TAG), the UE adjusts uplink timing for PUSCH/SRS/PUCCH transmission on all the serving cells in the TAG based on a value N_{TA,offset} that the UE expects to be same for all the serving cells in the TAG and based on the received timing advance command where the uplink timing for physical uplink shared channel (PUSCH), sounding reference signal (SRS), and/or physical uplink control channel (PUCCH) transmissions is the same for all the serving cells in the TAG.

For a band with synchronous contiguous intra-band evolved universal terrestrial radio access (E-UTRA) NR dual connectivity (EN-DC) in a band combination with non-applicable maximum transmit timing difference requirements, if the UE indicates ul-TimingAlignmentEUTRA-NR as ‘required’ and uplink transmission timing based on timing adjustment indication for a TAG from master cell group (MCG) and a TAG from secondary cell group (SCG) are determined to be different by the UE, the UE adjusts the transmission timing for PUSCH, SRS, and/or PUCCH transmission on all serving cells part of the band with the synchronous contiguous intra-band EN-DC based on timing adjustment indication for a TAG from a serving cell in MCG in the band. The UE is not expected to transmit a PUSCH, SRS, and/or PUCCH in one CG when the PUSCH, SRS, and/or PUCCH is overlapping in time, even partially, with random access preamble transmitted in another CG.

For a subcarrier spaceing (SCS) of 2^{μ}·15 kHz, the timing advance command for a TAG indicates the change of the uplink timing relative to the current uplink timing for the TAG in multiples of 16·64·T_{c}/2^{μ}. The start timing of the random access preamble is considered. A timing advance command, in case of random access response or in an absolute timing advance command MAC CE, TA, for a TAG indicates N_{TA} values by index values of T_{A}=0, 1, 2, . . . , 3846, where an amount of the time alignment for the TAG with SCS of 2^{μ}·15 KHz is N_{TA}=T_{A}·16·64/2^{μ}. N_{TA} is defined and is relative to the SCS of the first uplink transmission from the UE after the reception of the random access response or absolute timing advance command MAC CE. In other cases, a timing advance command, T_{A}, for a TAG indicates adjustment of a current N_{TA} value, N_{TA} old, to the new N_{TA} value, N_{TA_new}, by index values of T_{A}=0, 1, 2, . . . , 63, where for a SCS of 2^{μ}·15 kHz, N_{TA_new}=N_{TA_old}+ (T_{A}−31)·16·64/2^{μ}.

If a UE has multiple active UL bandwidth parts (BWPs) in a same TAG, including UL BWPs in two UL carriers of a serving cell, the timing advance command value is relative to the largest SCS of the multiple active UL BWPs. The applicable N_{TA_new} value for an UL BWP with lower SCS may be rounded to align with the timing advance granularity for the UL BWP with the lower SCS while satisfying the timing advance accuracy requirements. Adjustment of an N_{TA} value by a positive or a negative amount indicates advancing or delaying the uplink transmission timing for the TAG by a corresponding amount, respectively.

For a timing advance command received on uplink slot n and for a transmission other than a PUSCH scheduled by a RAR UL grant or a fallback RAR UL grant, or a PUCCH with hybrid automatic repeat request acknowledgement (HARQ-ACK) information in response to a success RAR, the corresponding adjustment of the uplink transmission timing applies from the beginning of uplink slot n+k+1+2^{μ}·K_{offset} where

$$k = ⌈ {N}_{slot}^{subframe , μ} \cdot ( {N}_{T , 1} + {N}_{T , 2} + {N}_{TA , max} + 0.5 ) / {T}_{sf} ⌉ ,$$

N_{T,1} is a time duration in msec of N1 symbols corresponding to a PDSCH processing time for UE processing capability 1 when additional PDSCH DM-RS is configured, N_{T,2} is a time duration in msec of N2 symbols corresponding to a PUSCH preparation time for UE processing capability 1, N_{TA,max} is the maximum timing advance value in msec that can be provided by a TA command field of 12 bits

$${N}_{slot}^{subframe , μ}$$

is the number of slots per subframe, T_{sf} is the subframe duration of 1 msec, and K_{offset}=K_{cell,offset}−K_{UE,offset}, where K_{cell,offset} is provided by cellSpecificKoffset and K_{UE,offset} is provided by a differential K_{offset} MAC CE command; otherwise, if not respectively provided, K_{cell,offset}=0 or K_{UE,offset}=0. N₁ and N₂ are determined with respect to the minimum SCS among the SCSs of all configured UL BWPs for all uplink carriers in the TAG and of all configured DL BWPs for the corresponding downlink carriers. For μ=0, the UE assumes N_{1,0}=14. Slot n and

$${N}_{slot}^{subframe , μ}$$

are determined with respect to the minimum SCS among the SCSs of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n is the last slot among uplink slot(s) overlapping with the slot(s) of PDSCH reception assuming T_{TA}=0, where the PDSCH provides the timing advance command and T_{TA}.

If a UE changes an active UL BWP between a time of a timing advance command reception and a time of applying a corresponding adjustment for the uplink transmission timing, the UE determines the timing advance command value based on the SCS of the new active UL BWP. If the UE changes an active UL BWP after applying an adjustment for the uplink transmission timing, the UE assumes a same absolute timing advance command value before and after the active UL BWP change. If the received downlink timing changes and is not compensated or is only partly compensated by the uplink timing adjustment without timing advance command, the UE changes N_{TA} accordingly. If two adjacent slots overlap due to a TA command, the latter slot is reduced in duration relative to the former slot. The UE does not change N_{TA} during an actual transmission time window for a PUSCH or a PUCCH transmission.

Using higher-layer ephemeris parameters for a serving satellite, if provided, a UE pre-compensates the two-way transmission delay on the service link based on

$${N}_{T A , a d j}^{UE}$$

that the UE determines using the serving satellite position and its own position. To pre-compensate the two-way transmission delay between the uplink time synchronization reference point and the serving satellite, the UE determines

$${N}_{T A , adj}^{c o m m o n}$$

based on one-way propagation delay Delay_{common}(t) that the UE determines as:

$${Delay}_{common} ( t ) = \frac{{TA}_{Common}}{2} + \frac{{TA}_{CommonDrift}}{2} \times ( t - {t}_{epoch} ) + \frac{{TA}_{CommonDriftVariant}}{2} \times {( t - {t}_{epoch} )}^{2}$$

where TA_{Common}, TA_{CommonDrift}, and TA_{CommonDriftVariant} are respectively provided by ta-Common, ta-CommonDrift, and ta-CommonDriftVariant and t_{epoch} is provided by epochTime which is the epoch time of ta-Common, ta-CommonDrift, and ta-CommonDriftVariant. Delay_{common}(t) provides a distance at time t between the serving satellite and the uplink time synchronization reference point divided by the speed of light. The uplink time synchronization reference point is the point where DL and UL are frame aligned with an offset given by N_{TA,offset}.

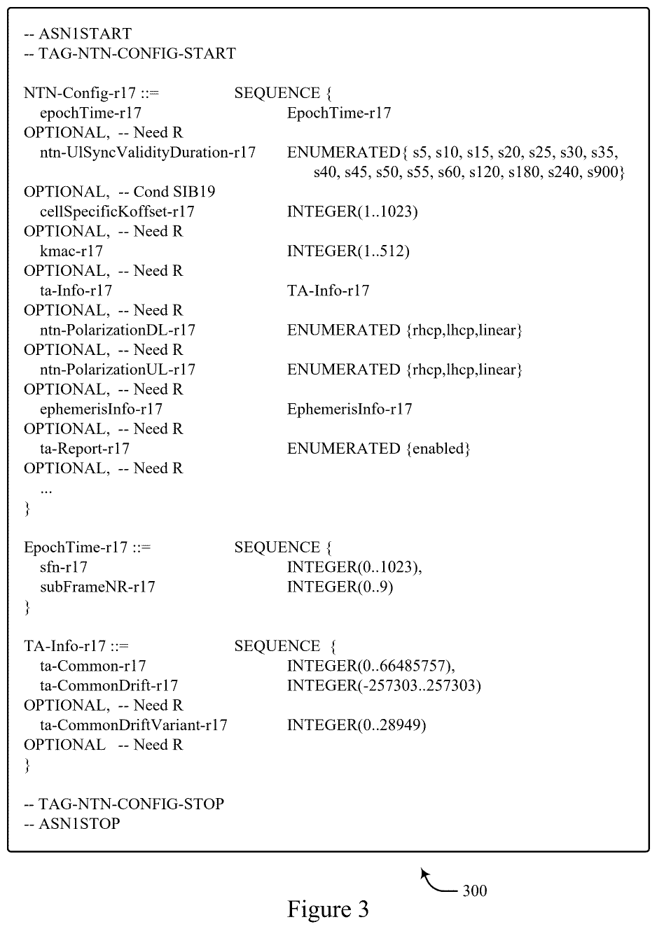

FIG. 3 illustrates an example IE 300 for NTN configuration in accordance with aspects of the present disclosure. In this example information element 300, NTN-Config IE, contains the essential parameter information needed for calculation of common TA and user specific. With reference to RRC signaling for TA calculation in NTN, the example information element 300 includes NTN-Config field descriptions.

EphemerisInfo: This field provides satellite ephemeris either in format of position and velocity state vector or in format of orbital parameters. This field is excluded when determining changes in system information, i.e. changes to ephemerisInfo should neither result in system information change notifications nor in a modification of value Tag in SIBI.

epochTime: Indicates the epoch time for the NTN assistance information. When explicitly provided through SIB, or through dedicated signaling, the EpochTime is the starting time of a DL sub-frame, indicated by a system frame number (SFN) and a sub-frame number signaled together with the assistance information. For serving cell, the field sfn indicates the current SFN or the next upcoming SFN after the frame where the message indicating the epochTime is received. For a neighbor cell, the sfn indicates the SFN nearest to the frame where the message indicating the epochTime is received. The reference point for epoch time of the serving NTN payload ephemeris and Common TA parameters is the uplink time synchronization reference point. If this field is absent, the epoch time is the end of system information (SI) window where this SIB19 is scheduled. This field is mandatory present when provided in dedicated configuration. If this field is absent in ntn-Config provided via NTN-NeighCellConfig the UE uses epoch time of the serving cell, otherwise the field is based on the timing of the serving cell, i.e. the SFN and sub-frame number indicated in this field refers to the SFN and sub-frame of the serving cell. In case of handover or conditional handover, this field is based on the timing of the target cell, i.e. the SFN and sub-frame number indicated in this field refers to the SFN and sub-frame of the target cell. For the target cell the UE considers epoch time, indicated by the SEN and sub-frame number in this field, to be the frame nearest to the frame in which the message indicating the epoch time is received. This field is excluded when determining changes in system information, i.e. changes to epochTime should neither result in system information change notifications nor in a modification of value Tag in SIBI.

cellSpecificKoffset: Scheduling offset used for the timing relationships that are modified for NTN. The unit of the field K_offset is number of slots for a given subcarrier spacing of 15 kHz. If the field is absent UE assumes value 0.

kmac: Scheduling offset provided by network if downlink and uplink frame timing are not aligned at gNB. It is needed for UE action and assumption on downlink configuration indicated by a MAC CE command in PDSCH. If the field is absent UE assumes value 0. For the reference subcarrier spacing value for the unit of K_mac in FR1, a value of 15 kHz is used. The unit of K_mac is number of slots for a given subcarrier spacing.

ntn-PolarizationDL: If present, this parameter indicates polarization information for downlink transmission on service link: including Right hand, Left hand circular polarizations (RHCP, LHCP) and Linear polarization.

ntn-PolarizationUL: If present, this parameter indicates Polarization information for uplink service link. If not present and ntn-PolarizationDL is present, UE assumes the same polarization for UL and DL.

ntn-UlSyncValidityDuration: A validity duration configured by the network for assistance information (i.e. Serving and/or neighbor satellite ephemeris and Common TA parameters) which indicates the maximum time duration (from epochTime) during which the UE can apply assistance information without having acquired new assistance information. The unit of ntn-UlSyncValidityDuration is second. Value s5 corresponds to 5 s, value s10 indicate 10 s and so on. This parameter applies to both connected and idle mode UEs. If this field is absent in ntn-Config provided via NTN-NeighCellConfig, the UE uses validity duration from the serving cell assistance information. This field is excluded when determining changes in system information, i.e. changes of ntn-UlSyncValidityDuration should neither result in system information change notifications nor in a modification of value Tag in SIB1. ntn-UlSyncValidityDuration is only updated when at least one of epochTime, ta-Info, ephemerisInfo is updated.

ta-Common: Network-controlled common timing advanced value and it may include any timing offset considered necessary by the network. ta-Common with value of 0 is supported. The granularity of ta-Common is 4.072×10\hat{ }(−3) μs. Values are given in unit of corresponding granularity. This field is excluded when determining changes in system information, i.e. changes of ta-Common should neither result in system information change notifications nor in a modification of value Tag in SIB1.

ta-CommonDrift: Indicates drift rate of the common TA. The granularity of ta-CommonDrift is 0.2×10\hat{ }(−3) μs/s. Values are given in unit of corresponding granularity. This field is excluded when determining changes in system information, i.e. changes of ta-CommonDrift should neither result in system information change notifications nor in a modification of value Tag in SIB1.

ta-CommonDriftVariant: Indicates drift rate variation of the common TA. The granularity of ta-CommonDriftVariation is 0.2×10\hat{ }(−4) μs/s\hat{ }2. Values are given in unit of corresponding granularity. This field is excluded when determining changes in system information, i.e. changes of ta-CommonDriftVariant should neither result in system information change notifications nor in a modification of value Tag in SIB1.

ta-Report: When this field is included in SIB19, it indicates reporting of timing advanced is enabled during Random Access due to RRC connection establishment or RRC connection resume, and during RRC connection reestablishment. When this field is included in ServingCellConfigCommon within dedicated signaling, it indicates TA reporting is enabled during Random Access due to reconfiguration with sync.

With reference to positioning measurements, the different DL measurements including DL positioning reference signal (PRS) reference signal received power (RSRP) (PRS-RSRP), DL reference signal time difference (RSTD) and UE receive-transmit (Rx-Tx) time difference required for the supported RAT-dependent positioning techniques are shown in Table 1 for positioning measurement definitions for DL-based and UL-based positioning. measurement configurations are specified as: 4 Pair of DL RSTD measurements can be performed per pair of cells. Each measurement is performed between a different pair of DL PRS Resources/Resource Sets with a single reference timing; and 8 DL PRS RSRP measurements can be performed on different DL PRS resources from the same cell.

TABLE 1
Positioning Measurement Definitions for DL-based and UL-based Positioning
DL PRS reference signal received power (DL PRS-RSRP)

| | |
|---|---|
| Definition | DL PRS reference signal received power (DL PRS-RSRP), is defined as the |
| | linear average over the power contributions (in 9) of the resource elements that |
| | carry DL PRS reference signals configured for RSRP measurements within the |
| | considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than the |
| | corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a Transmission |
| | Point (TP), defined by the first detected path in time. |
| | T_{UE-TX} is the UE transmit timing of uplink subframe #j that is closest in time to |
| | the subframe #i received from the TP. |
| | Multiple DL PRS or channel state information (CSI-RS) for tracking resources, |
| | as instructed by higher layers, can be used to determine the start of one |
| | subframe of the first arrival path of the TP. The time of the beginning of a |
| | subframe is determined by assuming the time durations of the OFDM symbols |
| | at the receiver are the same. |
| | For frequency range 1, the reference point for T_{UE-RX} measurement shall be the |
| | Rx antenna connector of the UE and the reference point for T_{UE-TX} measurement |
| | shall be the Tx antenna connector of the UE. For frequency range 2, the |
| | reference point for T_{UE-RX} measurement shall be the Rx antenna of the UE and |
| | the reference point for T_{UE-TX} measurement shall be the Tx antenna of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay of |
| | the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED, |
| | RRC_INACTIVE |

UL Angle of Arrival (UL AoA)

| | |
|---|---|
| Definition | UL Angle of Arrival (UL AoA) is defined as the estimated azimuth angle (A- |
| | AoA) and vertical angle (Z-AoA) of a UE with respect to a reference direction, |
| | wherein the reference direction is defined: |
| | In the global coordinate system (GCS), wherein estimated azimuth angle |
| | is measured relative to geographical North and is positive in a counter- |
| | clockwise direction and estimated vertical angle is measured relative to |
| | zenith and positive to horizontal direction |
| | In the local coordinate system (LCS), wherein estimated azimuth angle is |
| | measured relative to x-axis of LCS and positive in a counter-clockwise |
| | direction and estimated vertical angle is measured relative to z-axis of |
| | LCS and positive to x-y plane direction. The bearing, downtilt and slant |
| | angles of LCS as defined. |
| | The UL-AoA is determined at the gNB antenna for an UL channel |
| | corresponding to this UE. |

UL Relative Time of Arrival (T_{UL-RTOA})

| | |
|---|---|
| Definition | The UL Relative Time of Arrival (T_{UL-RTOA}) is the beginning of subframe i |
| | containing SRS received in Reception Point (RP) j, relative to the RTOA |
| | Reference Time. |
| | The UL RTOA reference time is defined as T₀ + t_{SRS}, where |
| | T₀ is the nominal beginning time of SFN 0 provided by SFN Initialization |
| | Time |
| | t_{SRS} = (10n_{f} + n_{sf}) × 10⁻³, where n_{f} and n_{sf} are the system frame |
| | number and the subframe number of the SRS, respectively. |
| | Multiple SRS resources can be used to determine the beginning of one subframe |
| | containing SRS received at a RP. |
| | The reference point for T_{UL-RTOA} shall be: |
| | for type 1-C base station: the Rx antenna connector, |
| | for type 1-O or 2-O base station: the Rx antenna (i.e. the center location of |
| | the radiating region of the Rx antenna), |
| | for type 1-H base station: the Rx Transceiver Array Boundary connector. |

gNB Rx − Tx time difference

| | |
|---|---|
| Definition | The gNB Rx − Tx time difference is defined as T_{gNB-RX} − T_{gNB-TX} |
| | Where: |
| | T_{gNB-RX} is the Transmission and Reception Point (TRP) received timing of |
| | uplink subframe #i containing SRS associated with UE, defined by the first |
| | detected path in time. |
| | T_{gNB-TX} is the TRP transmit timing of downlink subframe #j that is closest in |
| | time to the subframe #i received from the UE. |
| | Multiple SRS resources can be used to determine the start of one subframe |
| | containing SRS. |
| | The reference point for T_{gNB-RX} shall be: |
| | for type 1-C base station: the Rx antenna connector, |
| | for type 1-O or 2-O base station: the Rx antenna (i.e. the center location of |
| | the radiating region of the Rx antenna), |
| | for type 1-H base station: the Rx Transceiver Array Boundary connector. |
| | The reference point for T_{gNB-TX} shall be: |
| | for type 1-C base station: the Tx antenna connector, |
| | for type 1-O or 2-O base station: the Tx antenna (i.e. the center location of |
| | the radiating region of the Tx antenna), |
| | for type 1-H base station TS 38.104: the Tx Transceiver Array Boundary |
| | connector. |

UL SRS reference signal received path power (UL SRS-RSRPP)

| | |
|---|---|
| Definition | UL SRS reference signal received path power (UL SRS-RSRPP) is defined as |
| | the power of the linear average of the channel response at the i-th path delay of |
| | the resource elements that carry the received UL SRS signal configured for the |
| | measurement, where UL SRS-RSRPP for 1st path delay is the power |
| | contribution corresponding to the first detected path in time |
| | The reference point for UL SRS-RSRPP shall be: |
| | for type 1-C base station: the Rx antenna connector, |
| | for type 1-O or 2-O base station: based on the combined signal from |
| | antenna elements corresponding to a given receiver branch |
| | for type 1-H base station: the Rx Transceiver Array Boundary |
| | connector. |
| | For frequency range 1 and 2, if receiver diversity is in use by the gNB for UL |
| | SRS-RSRPP measurements: |
| | The reported UL SRS-RSRPP value for the first and additional paths |
| | shall be provided for the same receiver branch(es) as applied for UL SRS-RSRP |
| | measurements, or |
| | The reported UL SRS-RSRPP value for the first path shall not be lower |
| | than the corresponding UL SRS-RSRPP for the first path of any of the |
| | individual receiver branches and the reported UL SRS-RSRPP for the additional |
| | paths shall be provided for the same receiver branch(es) as applied UL SRS- |
| | RSRPP for the first path. |

In aspects of this disclosure, RAN1#122 agreement is taken into consideration. For the study on GNSS resilient operation, scenarios should be considered where: Scenario 1: The UE cannot rely on its GNSS for timing and frequency compensation on the service link. Scenario 2: There is a previously acquired GNSS based position, UE has not received GNSS information for time duration T from the last acquired GNSS position and hence, the GNSS accuracy is degraded for FFS: value of T; FFS: GNSS based UE location validity duration; and FFS: GNSS accuracy.

In aspects of this disclosure, RAN1#122bis agreement is taken into consideration. For the evaluation of GNSS resilient NR-NTN operation, consider the following assumptions: For scenario 1 and 2, the following time/frequency differences should be evaluated: The differential one-way delay (in μs) as calculated between the largest UE-Sat delay and smallest UE sat delay within the uncertainty area; and For UL performance evaluation 2 times differential one-way delay should be considered. The differential one-way Doppler/frequency offset (in ppm) is calculated between the largest UE-sat Doppler/frequency offset and smallest UE-sat Doppler/frequency offset within the uncertainty area. For UL performance evaluation, scaled one-way differential Doppler/frequency offset to determine UL differential Doppler/frequency offset should be considered. Scaling factor should be reported.

In aspects of this disclosure, RAN1#122bis agreement is taken into consideration. RAN1 to assess the impacts on connected mode during NR NTN GNSS-resilient operation, including at least: Impact on signaling overhead.

In aspects of this disclosure, RAN1#122bis observation is taken into consideration. For the study on GNSS resilient NR-NTN operation, the following three solutions for initial access to increase physical random access channel (PRACH) tolerance and reducing time/frequency uncertainty are listed based on inputs/discussions in RAN1#122bis.

A Solution 1: To improve robustness: Solutions based on modified random access procedures, using existing PRACH formats: Solution 1A: Multiple PRACH transmissions (e.g. with different roots or different formats or with different time/frequency pre-compensation using multiple reference locations within the uncertainty area) using existing PRACH formats. Solution 1B: New PRACH restricted sets. Solution 1C: Single PRACH transmission with multiple timing advance command (TAC)/frequency adjustment command (FAC) commands in RAR. Solution 1D: Signaling enhancements for Msg2 (e.g. enhanced TA command, frequency adjustment command, reference point adjustment command). Solution 1E: Selection of a set of existing PRACH root. Solution 1F: Using TA margin and resource overlap (RO) masking. Other solutions are not precluded.

A Solution 2: Solutions based on reducing time-frequency uncertainty: Solution 2A: Single/multi-satellite DL-TDOA based on current specifications. Solution 2B: multiple PRACH attempts based on different time/frequency pre-compensation hypotheses (e.g. based on multiple reference points within the uncertainty area). Solution 2C: Solutions based on broadcasting DL timestamp(s). Solution 2D: UE side time/frequency pre-compensation based on reference location. Solution 2E: service link time/frequency pre-compensation based on last acquired GNSS position. Solution 2F: UE side time/frequency pre-compensation based on reference signal. Other solutions are not precluded.

A Solution 3: Implementation-based techniques e.g. using a long enough PRACH processing window and multiple timing hypotheses for PRACH preamble reception with large max differential delay. Other Solutions are not precluded.

Aspects of the present disclosure include solutions for UE positioning with limited or no connectivity to satellite systems. In NR NTN transparent payload architectures, one or more UEs may pre-compensate the two-way transmission delay on the service link by determining its TA, which is derived by the one or more UEs using the serving satellite and its own determined or estimated positions. It is assumed that the NR NTN UE has GNSS capabilities and estimates its own location using GNSS. However, GNSS is susceptible to spoofing and jamming, which may result in the temporary unavailability of GNSS location and, eventually, denial of service to UEs, even if the UEs are in RRC_CONNECTED state, because the one or more UEs may need to calculate the TA multiple times due to GNSS satellite movement. In order to increase the robustness and resiliency of NTN system, the current interaction between NTN and the RAT-dependent positioning framework is enhanced during these temporary GNSS outage or loss durations, especially for those one or more UEs which are operating in RRC_IDLE, RRC_INACTIVE, or in RRC_CONNECTED states.

In aspects of the present disclosure, assuming that the network is aware of temporary or total unavailability of one or more UE's GNSS service, or when the GNSS positioning accuracy is below a required accuracy to derive a reasonable TA within a certain margin, the network may execute remedial or corrective action to enable a UE to compute its own position and/or location estimate using any number of supported or capable positioning methods, including RAT-dependent or RAT-independent methods to maintain UL time and frequency synchronization. Features support an enhanced configuration between a network node (e.g., NG-RAN, location management function (LMF)) and a UE in a coordinated manner, and/or support required information exchange between an NG-RAN node and the core network (e.g., LMF) to avoid loss of connectivity. In one or more implementations, a UE is enabled to still determine its own position and/or location despite a GNSS outage, or due to GNSS connectivity being unavailable. This may increase network robustness and reduce the time and/or frequency uncertainty of the NTN UEs and/or devices.

Aspects of the described techniques include implementations of procedures to enhance the robustness of one or more UEs during unavailability of GNSS or during GNSS-less operations. Implementations are described that may be implemented in combination with each other to enable the features and functionality of the UE-based NTN positioning disclosed herein. Aspects of a first implementation support UE-specific TA pre-compensation during initial access, which enables a UE to calculate its own position using non-GNSS assistance data that is broadcast via positioning system information blocks (posSIBs) in NTN SIB 19 messages, or in separate new SIB messages. This enhances positioning accuracy in GNSS-denied or GNSS-free environments by leveraging alternative RAT-dependent or RAT-independent assistance data elements, such as OTDOA, sensor barometric, NR DL-TDOA, and/or DL-AoD configurations.

Aspects of a second implementation include UE-initiated triggering of alternative positioning procedures upon loss of GNSS connectivity, enabling the configuration and use of both RAT-dependent and RAT-independent positioning methods to ensure reliable location estimation in NTN environments to support accurate UE-specific TA estimation. Aspects of a third implementation include NW-initiated triggering of alternative positioning procedures based on receiving an indication regarding the loss of GNSS connectivity, enabling the configuration, and use of RAT-dependent and/or RAT-independent positioning methods to ensure reliable location estimation in NTN environments to support accurate UE-specific TA estimation. In one or more of these implementations, a UE can explicitly or implicitly indicate the unavailability or outage of GNSS (or location inaccuracy information) to the network in the connected state and/or in the idle state, where this indication may either be initiated based on some explicit request configuration message by the network, or is based on an implicit indication by the network (e.g., a preconfigured criteria set by the network to initiate the indication), or the UE autonomously determines to initiate a signaling message.

With reference to the described first implementation for initial access pre-compensation to derive UE-specific TA, a UE may be provided with support and associated information to calculate its own position using the 3GPP positioning framework. However, conventional positioning procedures are triggered during normal RRC_CONNECTED state and are not supported during initial access. Positioning AD can be broadcast using positioning system information blocks (posSIBs). These posSIBs are included within RRC system information (SI) messages according to the respective specifications. These can be supported for LTE, 5G (NR), or 6GR. For example, in LTE, there is a single SystemInformationBlockPos IE, which is carried within the PosSystemInformation-r15-IEs. There is a mapping or relationship between the type of positioning SIB (posSibType) and the assistance data it carries, to enable location and/or position estimation. For NR, a single SIBpos IE is defined and is included in the PosSystemInformation-r16-IEs. There is typically a mapping between posSibType and the assistance data in SIBpos.

According to an aspect of this implementation, the one or more posSIB types or positioning AD elements, which are normally carried in a RRC SI message, are carried in NTN SIB 19 message, which is received by the UE before the transmission of the PRACH signal. These AD elements can be received periodically or aperiodically (e.g., one shot broadcast). In one or more implementations, the one or more posSIB types or positioning AD elements are carried with an enhanced SIB 1 or new SIB. Enhancing SIB 1 with such assistance data or configuration information can increase the overhead of SIB 1, which needs to be reliably detected and decoded by all UEs within a serving cell. A new SIB carrying the positioning information can increase the initial access latency, however it will also not impact SIB 1. This includes any one of the posSIB type and/or positioning AD elements shown in Table 2 for mapping of posSIB type and positioning AD elements. Notably, most of the posSIBs are GNSS assistance data to enable accurate UE-based GNSS positioning, however in the context of one or more implementations, it is further assumed that such positioning GNSS assistance data may not be broadcast based on the associated GNSS constellation loss, outage, or disruption. Therefore, one or more of the non-GNSS AD elements described in Table 2 may be used to provide configurations or assistance information to the UEs to assist in deriving a UE location (perform UE-based positioning). These include OTDOA Assistance Data, Barometric Assistance Data, TBS Assistance Data, NR DL-TDOA/DL-AOD Assistance Data, On-demand DL-PRS Configurations, Integrity Assistance Data for NR Positioning Methods, and/or SL positioning methods.

TABLE 2
Mapping of posSIB Type and Positioning AD Elements

| | posSibType | assistanceDataElement |
|---|---|---|
| GNSS Common Assistance | posSibType1-1 | GNSS-ReferenceTime |
| Data | posSibType1-2 | GNSS-ReferenceLocation |
| | posSibType1-3 | GNSS-IonosphericModel |
| | posSibType1-4 | GNSS-EarthOrientationParameters |
| | posSibType1-5 | GNSS-RTK-ReferenceStationInfo |
| | posSibType1-6 | GNSS-RTK-CommonObservationInfo |
| | posSibType1-7 | GNSS-RTK-AuxiliaryStationData |
| | posSibType1-8 | GNSS-SSR-CorrectionPoints |
| | posSibType1-9 | GNSS-Integrity-ServiceParameters |
| | posSibType1-10 | GNSS-Integrity-ServiceAlert |
| | posSibType1-11 | GNSS-LOS-NLOS-GridPoints |
| | posSibType1-12 | GNSS-SSR-IOD-Update |
| GNSS Generic Assistance | posSibType2-1 | GNSS-TimeModelList |
| Data | posSibType2-2 | GNSS-DifferentialCorrections |
| | posSibType2-3 | GNSS-NavigationModel |
| | posSibType2-4 | GNSS-RealTimeIntegrity |
| | posSibType2-5 | GNSS-DataBitAssistance |
| | posSibType2-6 | GNSS-AcquisitionAssistance |
| | posSibType2-7 | GNSS-Almanac |
| | posSibType2-8 | GNSS-UTC-Model |
| | posSibType2-9 | GNSS-AuxiliaryInformation |
| | posSibType2-10 | BDS-DifferentialCorrections |
| | posSibType2-11 | BDS-GridModelParameter |
| | posSibType2-12 | GNSS-RTK-Observations |
| | posSibType2-13 | GLO-RTK-BiasInformation |
| | posSibType2-14 | GNSS-RTK-MAC-CorrectionDifferences |
| | posSibType2-15 | GNSS-RTK-Residuals |
| | posSibType2-16 | GNSS-RTK-FKP-Gradients |
| | posSibType2-17 | GNSS-SSR-OrbitCorrections |
| | posSibType2-17a | GNSS-SSR-OrbitCorrectionsSet2 |
| | posSibType2-18 | GNSS-SSR-ClockCorrections |
| | posSibType2-18a | GNSS-SSR-ClockCorrectionsSet2 |
| | posSibType2-19 | GNSS-SSR-CodeBias |
| | posSibType2-20 | GNSS-SSR-URA |
| | posSibType2-20a | GNSS-SSR-URA-Set2 |
| | posSibType2-21 | GNSS-SSR-PhaseBias |
| | posSibType2-22 | GNSS-SSR-STEC-Correction |
| | posSibType2-23 | GNSS-SSR-GriddedCorrection |
| | posSibType2-24 | NavIC-DifferentialCorrections |
| | posSibType2-25 | NavIC-GridModelParameter |
| | posSibType2-26 | GNSS-LOS-NLOS-GriddedIndications |
| | posSibType2-27 | GNSS-SSR-SatellitePCVResiduals |
| OTDOA Assistance Data | posSibType3-1 | OTDOA-UE-Assisted |
| Barometric Assistance Data | posSibType4-1 | Sensor-AssistanceDataList |
| TBS Assistance Data | posSibType5-1 | TBS-AssistanceDataList |
| NR DL-TDOA/DL-AoD | posSibType6-1 | NR-DL-PRS-AssistanceData |
| Assistance Data | posSibType6-2 | NR-UEB-TRP-LocationData |
| | posSibType6-3 | NR-UEB-TRP-RTD-Info |
| | posSibType6-4 | NR-TRP-BeamAntennaInfo |
| | posSibType6-5 | NR-DL-PRS-TRP-TEG-Info |
| | posSibType6-7 | NR-PRU-DL-Info |
| On-demand DL-PRS | posSibType6-6 | NR-On-Demand-DL-PRS-Configurations |
| Configurations | | |
| Integrity Assistance Data for | posSibType7-1 | NR-IntegrityRiskParameters |
| NR Positioning Methods | posSibType7-2 | NR-IntegrityServiceParameters |
| | posSibType7-3 | NR-IntegrityServiceAlert |
| | posSibType7-4 | NR-IntegrityParameters |

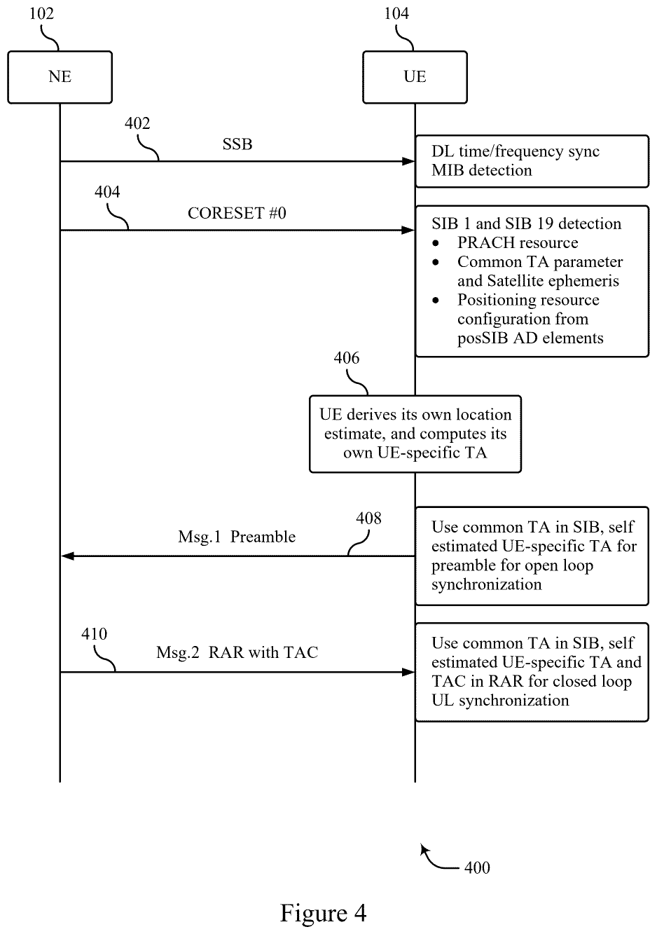

FIG. 4 illustrates an example process 400 as a signaling diagram for UE positioning AD in accordance with aspects of the present disclosure. In some examples, the example process 400 implements or is implemented by aspects of the wireless communications system 100, and may implement or be implemented by one or more devices, such as an NE 102 (e.g., a gNB, base station) and a UE 104. The example process 400 illustrates an example of UE positioning with limited or no connectivity to satellite systems in a wireless communications system. Alternative examples of the following may be implemented, where some aspects of the example process 400 are performed in a different order than described or are not performed. In some cases, aspects of the example process 400 may include additional features not mentioned below, or further process signaling may be added.

At 402, the NE 102 transmits a synchronization signal block (SSB) (e.g., as a first signaling) to the UE 104 for DL synchronization. The UE 104 acquires DL time and frequency synchronization and then decodes the master information block (MIB) (within the physical broadcast channel (PBCH)).

At 404, the NE 102 transmits control resource set 0 (CORESET #0) (e.g., as a second signaling) to the UE 104 for system information detection. The CORESET #0 is a predefined set of resources used for initial access and system information acquisition, as part of the physical downlink control channel (PDCCH) configuration. The PDCCH carries DL control information (DCI) for scheduling and control signaling. In particular, the CORESET #0 is used for SIB 1 scheduling and RAR. In this example, the UE 104 detects and decodes SIB 1 and SIB 19 messages. An (enhanced) SIB 1 contains general system information and/or positioning AD information. The SIB 19 contains NTN-specific information, including positioning AD, common TA parameter, and satellite ephemeris and/or positioning AD information. In one or more implementations, a new SIB is established that contains all the necessary RS configurations (e.g., DL-PRS) to calculate the position and/or location information of the UE. The UE leverages positioning AD elements (from posSIBs and/or SIB 19) to refine its location estimate. This reduces dependency on GNSS and enhances robustness in GNSS-denied or degraded scenarios.

At 406, and prior to the transmission of the PRACH preamble, the UE 104 determines a GNSS-independent location estimation, where the UE derives its own location estimate based on the one or more positioning AD elements contained in any of the received SIBs. The UE may then compute its own UE-specific TA.

At 408, the UE 104 transmits the PRACH preamble (Msg.1) (e.g., as a third signaling) to the NE 102 to initiate access. In implementations, before the PRACH preamble transmission, the UE uses the common TA from SIB 19, and uses its own self-estimated UE-specific TA (as derived from positioning AD elements in SIB 19 or posSIBs). This enables open-loop timing pre-compensation for initial access.

At 410, the NE 102 transmits RAR reception (Msg.2) (e.g., as a fourth signaling) to the UE 104. The RAR contains a timing advance command (TAC), and the UE 104 uses the common TA from SIB. The self-estimated UE-specific TA is based on derived UE location and/or position and TAC from RAR for closed-loop uplink synchronization.

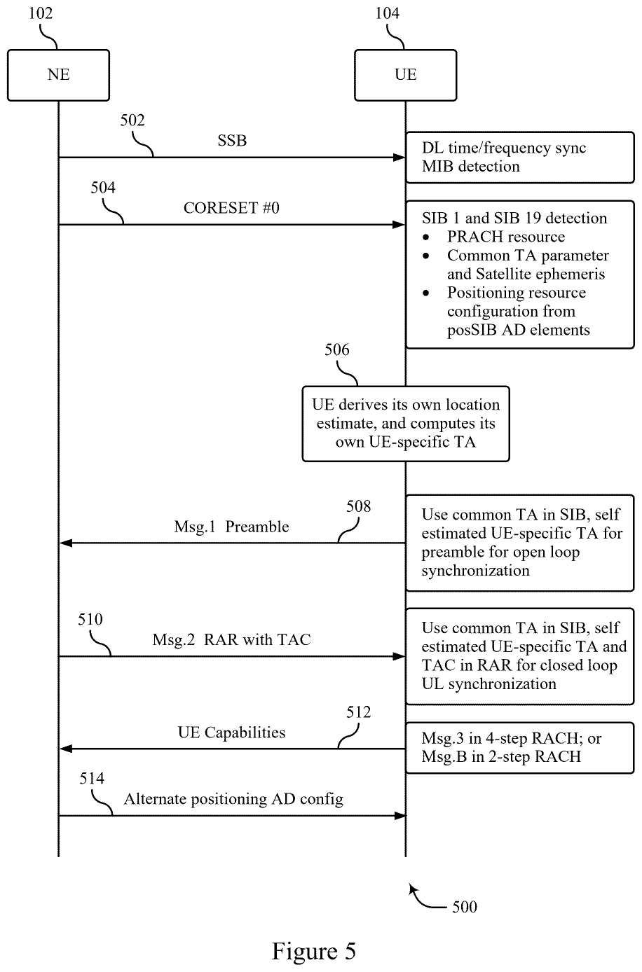

FIG. 5 illustrates another example process 500 as a signaling diagram for UE positioning AD in accordance with aspects of the present disclosure. In some examples, the example process 500 implements or is implemented by aspects of the wireless communications system 100, and may implement or be implemented by one or more devices, such as an NE 102 (e.g., a gNB, base station) and a UE 104. The example process 500 illustrates an example of UE positioning with limited or no connectivity to satellite systems in a wireless communications system. Alternative examples of the following may be implemented, where some aspects of the example process 500 are performed in a different order than described or are not performed. In some cases, aspects of the example process 500 may include additional features not mentioned below, or further process signaling may be added.

Similar to the steps 402-410 as shown and described with reference to the example process 400 in FIG. 4, the steps 502-510 of the example process 500 may be used to determine an initial position estimate and thus a UE-specific TA. However, since positioning AD is a common configuration applicable to multiple UEs, it may not provide the best estimate according to the specific UE's capabilities. Therefore, as describe below, the UE 104 may transmit some minimum or basic capabilities to the NE 102 (e.g., gNB) via a subsequent message (at 512), also known as message 3 in 4-step RACH or message B in 2-step RACH. The NE 102 (e.g., gNB, LMF) can then provide (at 514) an enhanced, alternate positioning AD configuration, which may then enable the UE (or multiple UEs) to calculate a more accurate positioning estimate, and determine a more accurate UE-specific TA.

At 502, the NE 102 transmits a synchronization signal block (SSB) (e.g., as a first signaling) to the UE 104 for DL synchronization. At 504, the NE 102 transmits CORESET #0 (e.g., as a second signaling) to the UE 104 for system information detection. At 506, and prior to the transmission of the physical random access channel (PRACH) preamble, the UE 104 determines a GNSS-independent location estimation, where the UE derives its own location estimate based on the one or more positioning AD elements contained in any of the received SIBs. The UE may then compute its own UE-specific TA. At 508, the UE 104 transmits the PRACH preamble (Msg. 1) (e.g., as a third signaling) to the NE 102 to initiate access. At 510, the NE 102 transmits RAR reception (Msg.2) (e.g., as a fourth signaling) to the UE 104. At 512, the UE 104 transmits UE capabilities (e.g., as a fifth signaling) to the NE 102. At 514, the NE 102 transmits an enhanced, alternate positioning AD configuration (e.g., as a sixth signaling) to the UE 104.

In one or more implementations, the gNB/NG-RAN node may initially request the positioning AD and/or posSIB information from the LMF using appropriate NR positioning protocol annex (NRPPa) signaling and/or messages, and receive a response from the LMF. This request or response from the gNB or LMF may be a one shot, periodic, or event triggered.

In other implementations, SIB 1, or SIB 19, or a new SIB may be segmented if positioning AD exceeds the SIB message limit. This allows for complete positioning broadcast information transmissions over multiple segments if the posSIB or positioning AD configuration payload is too large to be accommodated in a single SIB 1, or SIB 19, or new SIB transmission.

In other implementations, the UE may request for the positioning AD or posSIB information in an on-demand manner using either on-demand system information (SI) request framework using radio resource control (RRC) or on-demand positioning reference signal (PRS) framework using LTE positioning protocol (LPP), depending on the state of the UE. This allows the UE to detect and determine that GNSS has been lost and/or connectivity is unavailable, and then request for an alternative positioning assistance method from the network to calculate its own UE position. Another implementation may involve a pre-emptive trigger by the network to transmit positioning AD elements, if the network is aware of the GNSS loss or unavailable connection before the UE. Certain events may trigger such a transmission, including the radio link failure (RLF) for a specified time duration, based on monitoring a drop in the UL synchronization accuracy.

In other implementations, if the horizontal and/or vertical positioning accuracy requirement of the derived UE location or position based on a GNSS method or non-GNSS positioning method is not met, the UE may request for another non-GNSS positioning AD configuration. In other implementations, the accuracy may be expressed in terms of uncertainty of geographical area description (GAD) shapes or as a confidence value. This may be accomplished based on an on-demand SI request or on-demand DL-PRS request, where the request includes at least a configuration with higher positioning accuracy requirements (e.g., higher bandwidth, more DL-PRS density, and so forth).

With reference to an alternative implementation, a new NTN-specific SIB or posSIB may be implemented for GNSS-independent positioning AD. In an alternative approach, rather than relying on the posSIB or AD elements delivered through SIB 1 or SIB 19, the system may introduce a dedicated NTN system information block (NTN SIB) or a new NTN-specific posSIB, which carriers positioning-specific configurations or assistance data elements to derive the location and/or position information at the UE. This new SIB is designed to provide positioning AD that is fully independent of any GNSS configuration or dependency, such as by OTDOA assistance data, barometric assistance data, TBS assistance data, NR DL-TDOA assistance data, DL-AoD assistance data, on-demand DL-PRS configurations, integrity assistance data for NR positioning methods, or any combination thereof. The NTN SIB or NTN posSIB can be separately broadcast by the NG-RAN node or gNB and is specifically signaled when a UE detects the presence of this SIB prior to transmitting RACH preambles. The UE may use this information contained within this new NTN SIB or NTN posSIB to determine its own location and/or position, and thus derive its own UE-specific TA.

Upon detection of the NTN SIB or NTN posSIB, the UE is able to acquire the necessary positioning AD directly from the broadcast message, without requiring prior knowledge or configuration of GNSS status or parameters. This enables a UE to initiate pre-compensation and positioning procedures based solely on NTN-specific positioning information (e.g, RAT-dependent positioning configurations), which enhances resilience in scenarios where GNSS is unavailable or unreliable. The signaling of the NTN SIB or posSIB can be periodic or event-triggered, and its content may include NTN-specific parameters, DL-PRS, or any other RS used for positioning purposes, time-frequency resource allocations further comprising bandwidth, a number of PRBs, a number of symbols, a comb size, a muting pattern, a repetition configuration, a slot offset, a resource element offset, or any combination thereof, as well as other assistance information relevant for accurate UE location estimation in GNSS-free or GNSS-degraded environments. This mechanism allows for flexible and robust UE positioning, particularly beneficial for NTN deployments and use cases where GNSS coverage is intermittent or absent.

With reference to the described second implementation for UE-initiated RAT-dependent and/or RAT-independent positioning upon loss of GNSS connectivity, traditional 3GPP positioning triggers are realized based on location service requests (LCS) from external or inter LCS clients. Network-initiated location requests are triggered based on the network's need for one or more UE's position and/or location information (e.g., emergency/regulatory service or NTN-based network verified UE location). However, there is a need to support trigger and subsequent positioning procedures in the cases of critical events, such as loss in GNSS connectivity, which can negatively impact UL time and frequency synchronization, negatively impact closed-loop timing and frequency correction or pre-compensation procedures, and/or result in complete radio link failure or cause unnecessary state transitions (e.g., from RRC_CONNECTED state to RRC_INACTIVE/RRC_IDLE state).

According to aspects of this implementation, the network may receive an indication from the one or more UEs, in the form of a GNSS outage report describing the metadata details including the loss of one or more GNSS constellations, elapsed time since the GNSS loss, previous estimate position or location including uncertainty or accuracy, etc. This report may further include a binary indication of the outage, or one or more indicators of the outage of one or more GNSS constellations. This indication may be signaled via a dedicated SR channel or signal, such as by PUSCH, UL non-access stratum (NAS) message, UL LPP message, UL RRC message, and/or via an indication within an uplink control information (UCI) channel transmitted over an indicated or configured UL channel. The one or more UEs or devices may be in one or more supported operational states, including RRC_CONNECTED, RRC_INACTIVE, RRC_IDLE or any other sleep or standby states, when there is a GNSS outage or loss in GNSS connectivity. Example implementations of the uncertainty includes one or more of the uncertainty shapes associated to the Geographical Area Description. Examples include ellipsoid point with uncertainty circle, ellipsoid point with uncertainty ellipse, high accuracy ellipsoid point with uncertainty ellipse, and so forth.

In aspects of the implementation, one or more UEs may initiate one or more requests with the network to configure one or more UE-based RAT-dependent or RAT-independent positioning methods, including necessary assistance data comprising NTN-specific parameters, time-frequency resources, and so forth to determine its own position and/or location with a defined accuracy or confidence, or uncertainty shape (as described above) upon detection of loss of GNSS connectivity or during GNSS-free operations. These requests are initiated based on newly defined event triggers that may include a loss of GNSS connectivity, which prompts the UEs to transmit the one or more requests to the network. Depending on the network node, the implementation may support the network node to be a location server, e.g., LMF, AMF, or in other cases, an NG-RAN node. Furthermore, the loss of supported GNSS constellations may include: Global Positioning System (GPS)—The United States' GNSS; Galileo—The European Union's GNSS; GLONASS (Globalnaya Navigatsionnaya Sputnikovaya Sistema)—Russia's GNSS; BeiDou (BDS)—China's GNSS; QZSS (Quasi-Zenith Satellite System)—Japan's regional GNSS; NavIC (Navigation with Indian Constellation, or IRNSS)—India's regional GNSS; and/or SBAS (Satellite-Based Augmentation System)—These are systems that enhance other GNSS with integrity and accuracy improvements, such as Wide Area Augmentation System (WAAS), European Geostationary Navigation Overlay Service (EGNOS), Multi-functional Satellite Augmentation System (MSAS), and GPS Aided GEO Augmented Navigation (GAGAN).

Additionally, the various types of UE-based RAT-independent or RAT-dependent positioning methods that maybe initiated, subject to UE capability may include: A-GNSS: If one or more GNSS is lost, the UE may connect to another available GNSS subject to the UE's capabilities; Terrestrial Beacon; Sensor-based positioning; WLAN-based positioning; Bluetooth-based positioning; NR DL-TDoA positioning; NR DL-AoD positioning; NR Multi-RTT (if supported in future); SL-TDOA; SL-angle of arrival (AOA); SL-TOA; and/or SL-RTT (one-way or two-way RTT). Examples of these triggers are shown in the Table 3 of trigger events for UE-based RAT-independent or RAT-dependent positioning methods. The triggers can initiate the UE to obtain configurations and associated NTN-specific parameters related to UE-based RAT-dependent or RAT-independent positioning methods.

TABLE 3
Trigger Events for UE-based RAT-independent
or RAT-dependent Positioning Methods

| Events | Description |
|---|---|
| General Loss of | This event can be configured to the UE to |
| GNSS connectivity | provide an overall GNSS loss indication based |
| | on GNSS signals from one or more satellites not |
| | being detected. |
| Temporary Loss of | This event can be configured to provide a GNSS |
| GNSS connectivity | loss indication based on GNSS signals from one |
| | or more satellites not being temporarily |
| | detected, e.g., for a short period of time, time of |
| | GNSS loss, expected time of GNSS recovery/re- |
| | connection, type of GNSS connectivity loss, |
| | e.g., flag between temporary or permanent, error |
| | cause related to the type of GNSS loss, timer |
| | initiated based on GNSS connectivity loss |
| | triggered at start of detected loss of connectivity. |
| Permanent/total loss | This event can be configured to provide a GNSS |
| of GNSS connectivity | loss indication based on GNSS signals from one |
| | or more satellites not being permanently |
| | detected, e.g., for a long period of time. |
| Decrease in UE | This event is configured to the UE to detect |
| determined GNSS | whether the UE determined GNSS accuracy |
| Accuracy relative | decreases relative to a configured positioning |
| a positioning | accuracy threshold to meet the accuracy of the |
| accuracy threshold | timing and frequency UL compensation values. |
| | If the positioning accuracy is below the |
| | threshold indicating poor positioning accuracy, |
| | then UE may trigger the UE-based RAT- |
| | independent or RAT-dependent positioning. |

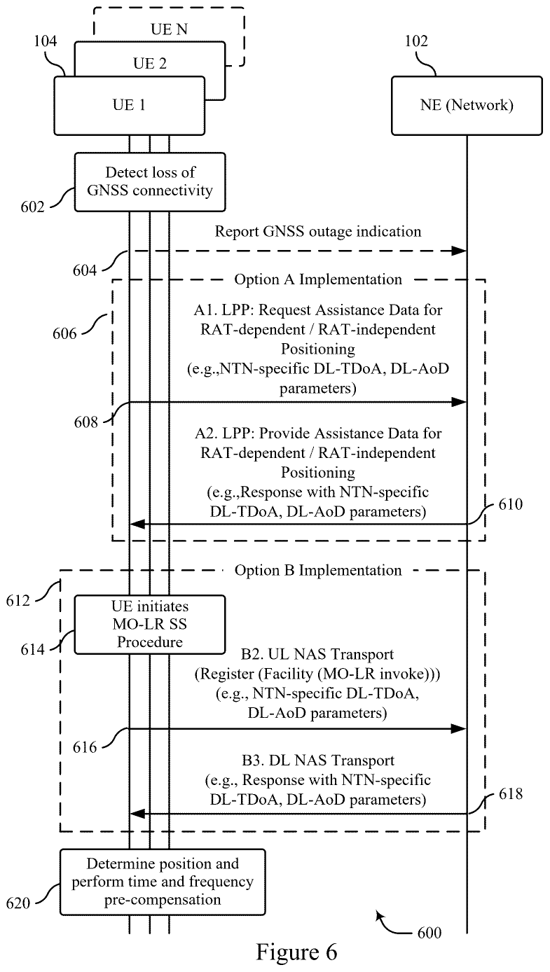

FIG. 6 illustrates an example process 600 as a signaling diagram for implementations of request and response information exchange for NTN-specific parameters related to a determination of UE-based RAT-dependent and/or RAT-independent positioning in accordance with aspects of the present disclosure. In some examples, the example process 600 implements or is implemented by aspects of the wireless communications system 100, and may implement or be implemented by one or more devices, such as an NE 102 (e.g., a gNB, base station) and a UE 104 (or multiple UEs). The example process 600 illustrates an example of UE positioning with limited or no connectivity to satellite systems in a wireless communications system. Alternative examples of the following may be implemented, where some aspects of the example process 600 are performed in a different order than described or are not performed. In some cases, aspects of the example process 600 may include additional features not mentioned below, or further process signaling may be added.

At 602, a UE 104 (or multiple UEs) detect or determine a loss of GNSS connectivity from one or more GNSS sources, including metadata, such as if the GNSS connectivity is unavailable as a temporary or permanent loss or disruption. At 604, the UE 104 may report the GNSS loss in connectivity based on any one or more the following metadata: GNSS outage timestamp: the time when the UE 104 detects a GNSS signal loss. Last list of GNSS location and/or position coordinates with associated timestamps, which may help the network estimate outage duration via NG-RAN or other sources. Last list of GNSS location and/or position accuracy. Last GNSS measurements. Estimated GNSS outage duration, such as if the UE can predict based on prior information (e.g., based on past connectivity loss durations). Location change rate, which indicates how quickly the UE moves, aiding use of last known location. GNSS clock accuracy, including details reduced or a change in clock accuracy related to GNSS if it falls below a threshold due to link issues or clock mismatch.

An option A implementation 606 supports the UE 104 to trigger a new or existing LPP connection with the location server (e.g., LMF) to request NR RAT-dependent and/or RAT-independent configuration information. At 608, the UE 104 transmits an LPP RequestAssistanceData message to the network, such as location server (e.g., LMF), based on the detected GNSS outage or loss. This message may contain common positioning information such as segmentation, periodic, or aperiodic, e.g., one shot transmission, assistance data request, and/or cell identifying information (e.g., LTE/NR/6G PCI, etc.). In other implementations, this request message may include UE-specific positioning requests including positioning QoS (e.g., accuracy), DL-PRS assistance data type, or positioning calculation assistance data types further including transmission reception point (TRP)/antenna reference point (ARP) location and/or ephemeris and/or orbital information, TRP beam antenna information for TN and/or NTN, relative time difference (RTD) information, line of sight (LOS) or non-line of sight (NLOS) information, NR/6G positioning integrity bounds, physical resource unit (PRU) information, UE-initiated on-demand PRS request, pre-configured assistance data, positioning integrity assistance information, expected AoD or AoA information or combination thereof, single-satellite TDoA, multi-satellite TDOA, single satellite DL-AoD, multi-satellite DL-AoD, timing drift information (e.g., TOA drifts), and/or subframe offsets and so forth. These positioning AD elements may be signaled as part of a common positioning method or specific positioning methods (e.g., DL-TDOA, DL-angle of departure (AOD)).

At 610, the NE 102 transmits and the UE 104 receives an LPP Provide AssistanceData message from the network, such as a location server (e.g., LMF), based on the detected GNSS outage or loss. The UE 104 may receive the assistance data in a periodic or aperiodic manner. The configuration message may include one or more of the requested information, subject to the availability of the information and/or at the discretion of the network. In implementations, this configuration message is transmitted using UE-specific signaling to each UE, while in other implementations, this configuration message is transmitted via broadcast signaling, using SIB or posSIBs to multiple UEs within a certain coverage area or validity area.

An option B implementation 612 supports the UE to initiate (at 614) a new or existing mobile-originated location request (MO-LR) supplementary service (SS) message with the AMF to request NR RAT-dependent and/or RAT-independent configuration information, which can also carry LPP positioning information as a LPP message container. At 616, the UE 104 transmits an UL NAS transport message to the NE 102 (network such as AMF), based on the detected GNSS outage or loss. This SS message can carry the same LPP request message (step 608) in the option A implementation 606 as a LPP message container. The message contents may include the following example information elements: molr-Type, lcs-QoS, IcsClientExternalID, mlc-Number, gpsAssistance Data, supportedGADShapes, lcsService TypeID, ageOfLocationInfo, locationType, pseudonymIndicator, h-gmlc-address, locationEstimate, velocityEstimate, reference Number, periodicLDRInfo, aperiodic provide assistance data transmission locationUpdateRequest, sequence Number, terminationCause, mo-IrShortCircuit, ganssAssistance Data, multiplePositioningProtocolPDUs, locationInfo, scheduledLocTime and NTN specific positioning parameters, such as timing drift information (e.g., TOA drifts), subframe offsets, ephemeris and orbital information, and/or NTN-specific parameters.

At 618, the NE 102 transmits and the UE 104 receives a DL NAS transport message from the network such as AMF, based on the received request and/or detected GNSS outage or loss. This message may be received in a periodic or aperiodic manner. This SS message can carry the same LPP response message (step 610) in the option A implementation 606 as a LPP message container. The message contents may include any of the following example information elements: locationEstimate, velocityEstimate, add-LocationEstimate, decipheringKeys, reference Number, h-gmlc-address, mo-lrShortCircuit, reportingPLMNList, timestampOfLocationEstimate, ephemeris, orbital information, and/or NTN-specific information.

At 620, the UE 104 (or multiple UEs) perform a position and/or location determination and subsequently perform time and frequency pre-compensation. In an alternative implementation, the UE 104 leverages a hybrid procedure involving both proactive and reactive mechanisms to address GNSS outages at the UE. Upon detecting a loss of GNSS connectivity, the UE can first attempt to utilize any cached or pre-configured assistance data or previously received configuration parameters to maintain its positioning accuracy locally, e.g., based on RAT-independent methods or already transmitted RSs from the network (e.g., DL-PRS). If the pre-configured assistance data is insufficient or outdated to meet the accuracy at least met during the operation of GNSS, the UE initiates a positioning assistance request through an existing radio bearer, such as a control plane or user plane connection, without necessarily establishing a new dedicated signaling session (e.g., a new LPP session). This request may include context about the outage, such as the estimated time of loss, current motion state, and last known location and corresponding accuracy.

The network (e.g., NE 102), upon receiving such a request, evaluates the UE's context and determines the most efficient method to restore or supplement positioning capabilities assuming that GNSS connectivity remains unavailable. This may involve distributing minimal, incremental, or delta assistance data (such as updated ephemeris or satellite status) using group-based or area-specific broadcast mechanisms, especially for UEs in similar outage conditions, to optimize signaling overhead. Examples of broadcast mechanisms may include the positioning SIBs (posSIBs), which broadcast positioning related system information to multiple UEs. Example implementations of area-specific broadcast mechanisms may include the use of the validity area to indicate the validity of the broadcasted positioning SIB information, which may further include NR/6G PCI, NR cell global identifier (NCGI)/6G cell global identifier (CGI), and/or absolute radio frequency channel number (ARFCN). The validity area also be mapped the beam footprint of the NTN satellite. Additionally, the network can dynamically adjust the reporting intervals and required measurement types based on the severity and anticipated duration of the GNSS outage, ensuring that each UE receives tailored or specific support while maintaining efficient resource utilization. This alternative prioritizes flexibility, leveraging both stored, pre-configured, and/or network-provided configuration data, and adapts the signaling and data exchange strategy according to real-time conditions.

With reference to the described third implementation for network-initiated RAT-dependent and/or RAT-independent positioning upon loss of GNSS connectivity, the network may have already detected and determined that there is a GNSS outage or loss in GNSS connectivity for one or more UEs. Detection and assessment can rely on data provided by other network components or operations and maintenance systems (OAM), such as a GNSS outage report. This report typically contains metadata detailing aspects like the loss of one or more GNSS constellations, the duration since the outage began, and a previous list of NTN positions or location estimates, ephemeris, and/or orbital information along with their associated uncertainty or accuracy. According to this aspect of the implementation, the network configures the one or more UEs with the desired one or more RAT-dependent and/or RAT-independent positioning methods based on the received information from another node, e.g., NG-RAN or Core Network node, OAM, indicating that the UE is experiencing a GNSS outage or a temporary or permanent loss in GNSS connectivity.

In example implementations of the above aspects, the network may include the LMF, which in turn coordinates with an NG-RAN node which may be the serving cell or neighboring or target cell of the one or more UEs, to provide time-frequency resources (e.g. DL-PRS resources), to enable UE-based position and/or location determination. In other example implementations, the network may include the AMF, which in turn coordinates with the LMF and NG-RAN node which may be the serving cell or neighboring/target cell of the one or more UEs, to provide the necessary configuration parameters, to enable UE-based position and/or location determination. In other example implementations, the network may include the NG-RAN node, which in turn coordinates with the LMF and/or other core network nodes which may be the serving cell or neighboring/target cell of the one or more UEs, to provide the necessary configuration parameters, to enable UE-based position and/or location determination.

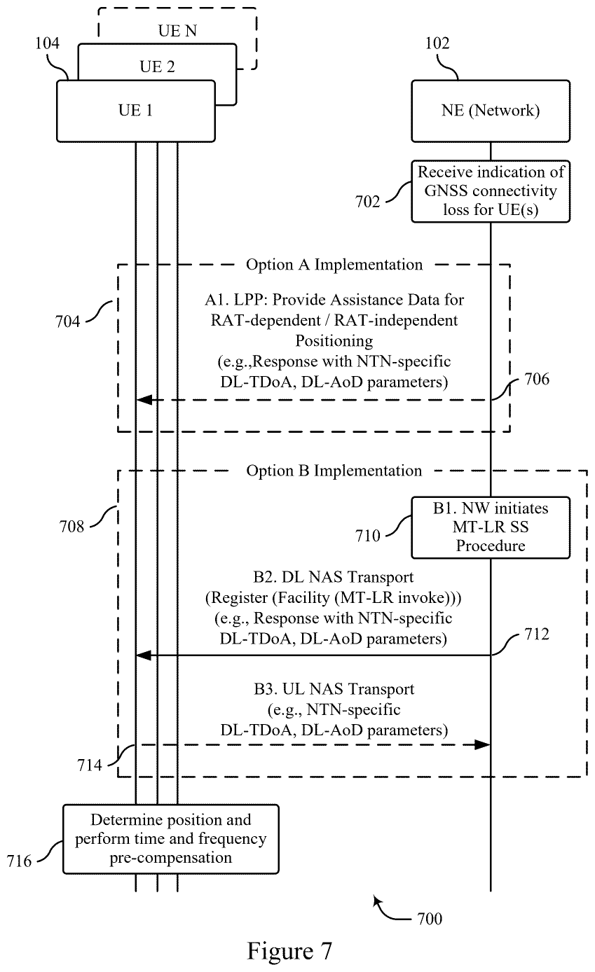

FIG. 7 illustrates an example process 700 as a signaling diagram for implementations of request and response information exchange related to NW-initiated UE-based RAT-dependent and/or RAT-independent positioning based on loss of GNSS connectivity in accordance with aspects of the present disclosure. In some examples, the example process 700 implements or is implemented by aspects of the wireless communications system 100, and may implement or be implemented by one or more devices, such as an NE 102 (e.g., a gNB, base station) and a UE 104 (or multiple UEs). The example process 700 illustrates an example of UE positioning with limited or no connectivity to satellite systems in a wireless communications system. Alternative examples of the following may be implemented, where some aspects of the example process 700 are performed in a different order than described or are not performed. In some cases, aspects of the example process 700 may include additional features not mentioned below, or further process signaling may be added.

At step 702, the NE 102 receives information regarding a loss of GNSS connectivity for one or more UEs, including metadata, such as if the GNSS connectivity is unavailable as a temporary or permanent loss or disruption. The information received about the loss of GNSS connectivity may be based on any one or more of the following metadata: GNSS outage timestamp: the time when the UE 104 detects a GNSS signal loss. Last list of GNSS location and/or position coordinates with associated timestamps, which may help the network estimate outage duration via NG-RAN or other sources. Last list of GNSS location and/or position accuracy. Last GNSS measurements. Estimated GNSS outage duration, such as if the UE can predict based on prior information (e.g., based on past connectivity loss durations). Location change rate, which indicates how quickly the UE moves, aiding use of last known location. GNSS clock accuracy, including details reduced or a change in clock accuracy related to GNSS if it falls below a threshold due to link issues or clock mismatch.

An option A implementation 704 supports the network to trigger a new or existing LPP connection with the UE 104 to provide NR RAT-dependent and/or RAT-independent configuration information. At 706, the NE 102 (network, such as location server, e.g., LMF) transmits an LPP Provide AssistanceData message to the UE 104 based on the detected GNSS outage or loss. This configuration message may contain common positioning configuration information such as segmentation, periodic assistance or aperiodic, e.g., one shot transmission data request, cell identifying information (e.g., LTE/NR/6G PCI, etc.). In other implementations, this configuration message may include UE-specific positioning requests, including DL-PRS assistance data type or positioning calculation assistance data types further including TRP/ARP location and/or ephemeris and/or orbital information, TRP beam antenna information for TN and/or NTN, RTD information, LOS/NLOS information, NR/6G positioning integrity bounds, PRU information, UE-initiated on-demand PRS request, pre-configured assistance data, positioning integrity assistance information, expected AoD or AoA information or combination thereof, single-satellite TDoA, multi-satellite TDOA, single satellite DL-AoD, multi-satellite DL-AoD, timing drift information (e.g., TOA drifts), subframe offsets, and so forth. These positioning AD elements elements may be signaled as part of a common positioning method or specific positioning methods (e.g., DL-TDOA, DL-AOD). In implementations, this configuration message is transmitted using UE-specific signaling to each UE, while in other implementations, this configuration message is transmitted via broadcast signaling, using SIB or posSIBs to multiple UEs within a certain coverage area.

An option B implementation 708 supports the network to trigger transmission of a new or existing supplementary service (SS) message to the one or more UEs to provide NR RAT-dependent and/or RAT-independent configuration information, which can also carry LPP positioning information as a LPP message container. At 710, the NE 102 (network) initiates the MT-LR SS procedure. At 712, the NE 102 (network) transmits and the UE 104 receives a DL NAS transport message from the network (e.g., AMF) based on the detected GNSS outage or loss. This message may be received in a periodic or aperiodic manner. This SS message can carry the same LPP positioning configuration message (step 706) in the option A implementation 704 as a LPP message container. The message contents may comprise of the following exemplary self-explanatory information elements: lcs-QoS, IcsClientExternalID, mlc-Number, gpsAssistanceData, supportedGADShapes, lcsService TypeID, ageOfLocationInfo, locationType, pseudonymIndicator, h-gmlc-address, locationEstimate, velocityEstimate, referenceNumber, periodicLDRInfo, aperiodic provide assistance data transmission locationUpdateRequest, sequence Number, terminationCause, ganssAssistance Data, multiplePositioningProtocolPDUs, locationInfo, scheduledLoc Time, ephemeris and orbital information, and/or NTN-specific parameters or IEs.

At 714, the UE 104 transmits an optional UL NAS transport message to the NE 104 (network such as AMF) based on the detected GNSS outage or loss. This SS message can carry the information element related to the UE determined position and/or location information as a LPP message container (e.g., using LPP ProvideLocationInformation message). The message contents may include any of the following IEs: a determined location information, associated accuracy and NTN specific positioning parameters, such as ephemeris and orbital information, and/or NTN-specific parameters or IEs. At 716, the UEs impacted by the loss of GNSS connectivity can perform position and/or location determinations, and subsequently perform time and frequency pre-compensation.

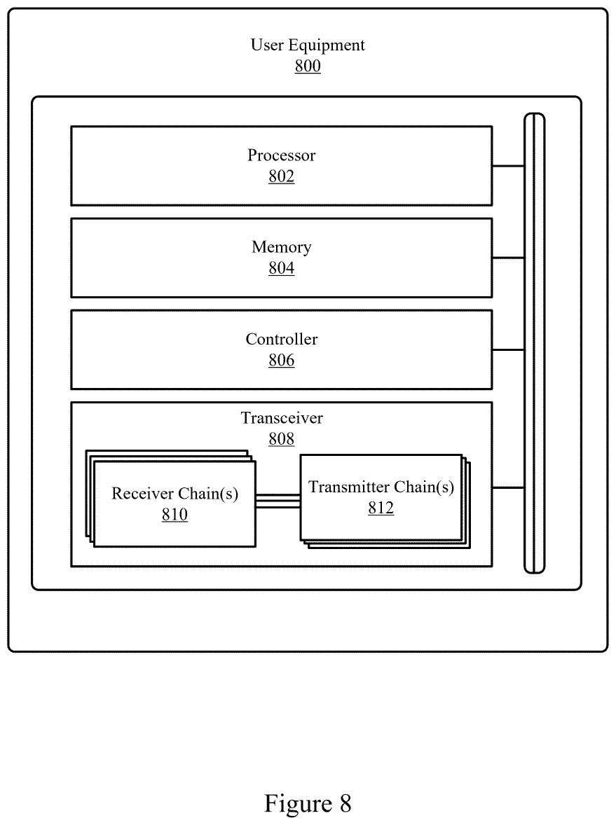

FIG. 8 illustrates an example of a UE 800 in accordance with aspects of the present disclosure. In some examples, the UE 800 may be an example of a UE as described with reference to FIGS. 1-7. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field-programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to or operable to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving positioning AD for UL time and frequency synchronization; determining a location of the UE using a positioning method if GNSS connectivity is unavailable; and determining timing pre-compensation values and frequency pre-compensation values for UL transmission based on the determined location of the UE. In this manner, the UE 800 supports receiving positioning AD from the network if GNSS connectivity is unavailable, and the UE can determine its own position and/or location based on the positioning AD associated with RAT-dependent and/or RAT-independent positioning determination methods to maintain UL time and frequency synchronization.

Additionally, or alternatively, the UE 800 may be configured to or operable to support the positioning method is one of one or more non-GNSS positioning methods, determine that the GNSS connectivity is unavailable, and transmit a request for the positioning AD associated with one or more of the non-GNSS positioning methods. This aspect provides that if GNSS connectivity is unavailable, the UE 800 can utilize a non-GNSS positioning method, as well as transmit a request to the network for the associated positioning AD.

Additionally, or alternatively, the UE 800 may be configured to or operable to support to determine that the GNSS connectivity is unavailable due to a system outage or a signal disruption, or due to GNSS accuracy failing to meet an accuracy threshold for pre-compensation determination, and one of: determine and transmit an indication of the system outage or the signal disruption over a period of time; or determine and transmit the indication that the system outage or the signal disruption is temporary or permanent. This aspect provides that the UE 800 can report to the network when GNSS connectivity is unavailable, in which case network can respond with alternative positioning AD associated with one or more non-GNSS positioning methods.

Additionally, or alternatively, the UE 800 may be configured to or operable to support the positioning AD of the one or more non-GNSS positioning methods is radio access technology (RAT)-dependent positioning AD or RAT-independent positioning AD; and the positioning AD comprises one or more of observed time difference of arrival (OTDOA) positioning AD, barometric positioning AD, terrestrial beacon system (TBS) assistance data, new radio (NR) downlink time difference of arrival (DL-TDOA) positioning AD, downlink angle of departure (DL-AoD) positioning AD, on-demand downlink positioning reference signal (DL-PRS) configurations, integrity assistance data for NR positioning methods, or sidelink (SL) positioning AD. This aspect provides that the UE 800 can utilize positioning AD from any number of various non-GNSS positioning methods and determine its own position and/or location.

Additionally, or alternatively, the UE 800 may be configured to or operable to support the positioning AD includes at least DL-PRS time-frequency information for computing the determined location of the UE; and the DL-PRS time-frequency information comprises bandwidth, a number of physical resource blocks (PRBs), a number of symbols, a comb size, a muting pattern, a repetition configuration, a slot offset, or a resource element offset. This aspect provides that the UE 800 can utilize various data included in positioning AD and determine its own position and/or location.

Additionally, or alternatively, the UE 800 may be configured to or operable to support to utilize one or more of LPP or MO-LR signaling framework for transmission and/or reception of the positioning AD. This aspect provides that the UE 800 can utilize various signaling frameworks for reporting that GNSS connectivity is unavailable, and to receive alternative assistance data from the network.

Additionally, or alternatively, the UE 800 may be configured to or operable to support the request for the positioning AD of the one or more non-GNSS positioning methods and the determined location comprises one or more of: a first indication of horizontal positioning accuracy, uncertainty, or confidence; or a second indication of vertical positioning accuracy, uncertainty, or confidence. This aspect provides that the UE 800 can request, from the network, alternate positioning AD and the request includes one or more indications of current positioning accuracy and reliability at the UE.

Additionally, or alternatively, the UE 800 may be configured to or operable to support to transmit an on-demand request for the positioning AD associated with at least one different non-GNSS positioning method if a positioning accuracy requirement of the determined location of the UE is not met. This aspect provides that the UE 800 can request, from the network, alternate positioning AD and the request includes one or more indications of current positioning accuracy and reliability at the UE.

Additionally, or alternatively, the UE 800 may be configured to or operable to support to receive the positioning AD in one or more of SIB 1, SIB 19, or a SIB established for NTN GNSS-free operation. This aspect provides that the UE 800 can receive, from the network, the positioning AD in various forms of configuration.

Additionally, or alternatively, the UE 800 may be configured to or operable to support the GNSS connectivity being unavailable triggers one or more of UE-initiated positioning procedures or network (NW)-initiated positioning procedures. This aspect provides that the UE and/or the network may detect or determine that GNSS connectivity is unavailable, and begin to take remedial action to provide alternative positioning AD from one or more non-GNSS positioning methods.

Additionally, or alternatively, the UE 800 may be configured to or operable to support the timing pre-compensation values include a UE-specific timing advance, and the frequency pre-compensation values include a doppler compensation or a doppler shift. This aspect provides that the UE 800 determines its own position and/or location based on alternative positioning AD when GNSS connectivity is unavailable.

Additionally, or alternatively, the UE 800 may be configured to or operable to support the positioning AD comprises information to enable the UE to derive its own location, and the positioning AD is configured for aperiodic transmission or periodic transmission. This aspect provides that the UE 800 can request and/or receive the positioning AD to determine its own position and/or location when GNSS connectivity is unavailable.

Additionally, or alternatively, the UE 800 may support at least one memory (e.g., the memory 804) and at least one processor (e.g., the processor 802) coupled with the at least one memory and configured to or operable to cause the UE to receive positioning AD for UL time and frequency synchronization; determine a location of the UE using a positioning method if GNSS connectivity is unavailable; and determine timing pre-compensation values and frequency pre-compensation values for UL transmission based on the determined location of the UE.

Additionally, or alternatively, the UE 800 may be configured to support any one or combination of: the positioning method is one of one or more non-GNSS positioning methods; the at least one processor is operable to cause the UE to determine that the GNSS connectivity is unavailable, and transmit a request for the positioning AD associated with one or more of the non-GNSS positioning methods. The at least one processor is operable to cause the UE to determine that the GNSS connectivity is unavailable due to a system outage or a signal disruption, or due to GNSS accuracy failing to meet an accuracy threshold for pre-compensation determination, and one of determine and transmit an indication of the system outage or the signal disruption over a period of time, or determine and transmit the indication that the system outage or the signal disruption is temporary or permanent. The positioning AD of the one or more non-GNSS positioning methods is RAT-dependent positioning AD or RAT-independent positioning AD, and the positioning AD comprises one or more of OTDOA positioning AD, barometric positioning AD, TBS assistance data, NR DL-TDOA positioning AD, DL-AoD positioning AD, on-demand DL-PRS configurations, integrity assistance data for NR positioning methods, or SL positioning AD.

Additionally, or alternatively, the UE 800 may be configured to support any one or combination of: the positioning AD includes at least DL-PRS time-frequency information for computing the determined location of the UE, and the DL-PRS time-frequency information comprises bandwidth, a number of PRBs, a number of symbols, a comb size, a muting pattern, a repetition configuration, a slot offset, or a resource element offset. The at least one processor is operable to cause the UE to utilize one or more of LPP or MO-LR signaling framework for transmission and/or reception of the positioning AD. The request for the positioning AD of the one or more non-GNSS positioning methods and the determined location comprises one or more of a first indication of horizontal positioning accuracy, uncertainty, or confidence; or a second indication of vertical positioning accuracy, uncertainty, or confidence. The at least one processor is operable to cause the UE to transmit an on-demand request for the positioning AD associated with at least one different non-GNSS positioning method if a positioning accuracy requirement of the determined location of the UE is not met. The at least one processor is operable to cause the UE to receive the positioning AD in one or more of SIB 1, SIB 19, or a SIB established for NTN GNSS-free operation. The GNSS connectivity being unavailable triggers one or more of UE-initiated positioning procedures or NW-initiated positioning procedures. The timing pre-compensation values include a UE-specific timing advance, and the frequency pre-compensation values include a doppler compensation or a doppler shift. The positioning AD comprises information to enable the UE to derive its own location, and the positioning AD is configured for aperiodic transmission or periodic transmission.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

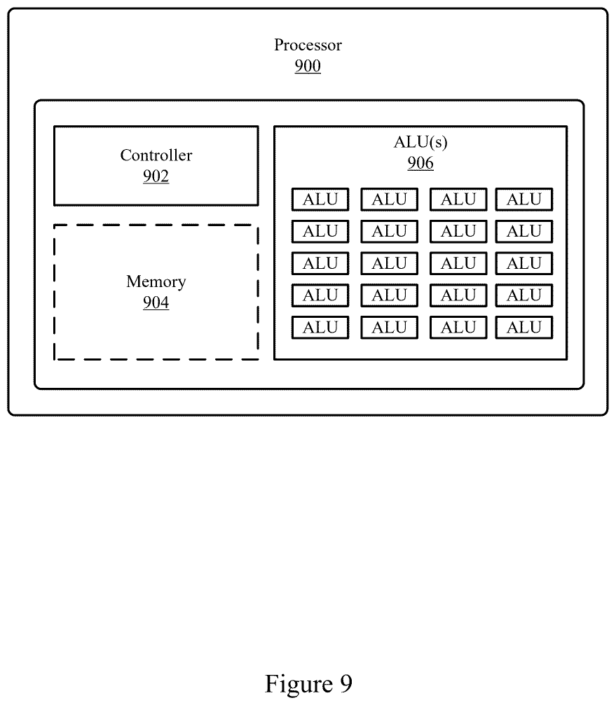

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to support at least one controller (e.g., the controller 902) coupled with at least one memory (e.g., the memory 904) and configured to or operable to cause the processor to receive positioning AD for UL time and frequency synchronization; determine a location of the UE using a positioning method if GNSS connectivity is unavailable; and determine timing pre-compensation values and frequency pre-compensation values for UL transmission based on the determined location of the UE.

Additionally, the processor 900 may be configured to or operable to support any one or combination of the positioning method is one of one or more non-GNSS positioning methods; the at least one processor is operable to cause the UE to determine that the GNSS connectivity is unavailable, and transmit a request for the positioning AD associated with one or more of the non-GNSS positioning methods. The at least one processor is operable to cause the UE to determine that the GNSS connectivity is unavailable due to a system outage or a signal disruption, or due to GNSS accuracy failing to meet an accuracy threshold for pre-compensation determination, and one of determine and transmit an indication of the system outage or the signal disruption over a period of time, or determine and transmit the indication that the system outage or the signal disruption is temporary or permanent. The positioning AD of the one or more non-GNSS positioning methods is RAT-dependent positioning AD or RAT-independent positioning AD, and the positioning AD comprises one or more of OTDOA positioning AD, barometric positioning AD, TBS assistance data, NR DL-TDOA positioning AD, DL-AoD positioning AD, on-demand DL-PRS configurations, integrity assistance data for NR positioning methods, or SL positioning AD.

Additionally, the processor 900 may be configured to or operable to support any one or combination of the positioning AD includes at least DL-PRS time-frequency information for computing the determined location of the UE, and the DL-PRS time-frequency information comprises bandwidth, a number of PRBs, a number of symbols, a comb size, a muting pattern, a repetition configuration, a slot offset, or a resource element offset. The at least one processor is operable to cause the UE to utilize one or more of LPP or MO-LR signaling framework for transmission and/or reception of the positioning AD. The request for the positioning AD of the one or more non-GNSS positioning methods and the determined location comprises one or more of a first indication of horizontal positioning accuracy, uncertainty, or confidence; or a second indication of vertical positioning accuracy, uncertainty, or confidence. The at least one processor is operable to cause the UE to transmit an on-demand request for the positioning AD associated with at least one different non-GNSS positioning method if a positioning accuracy requirement of the determined location of the UE is not met. The at least one processor is operable to cause the UE to receive the positioning AD in one or more of SIB 1, SIB 19, or a SIB established for NTN GNSS-free operation. The GNSS connectivity being unavailable triggers one or more of UE-initiated positioning procedures or NW-initiated positioning procedures. The timing pre-compensation values include a UE-specific timing advance, and the frequency pre-compensation values include a doppler compensation or a doppler shift. The positioning AD comprises information to enable the UE to derive its own location, and the positioning AD is configured for aperiodic transmission or periodic transmission.

The processor 900 may support wireless communication in accordance with examples as disclosed herein. The processor 900 may be configured to support at least one controller (e.g., the controller 902) coupled with at least one memory (e.g., the memory 904) and configured to or operable to cause the processor to transmit positioning AD for UL time and frequency synchronization by a UE; receive a request for the positioning AD associated with one or more non-GNSS positioning methods if GNSS connectivity is unavailable; and transmit the positioning AD in one or more of SIB 1, SIB 19, or a SIB established for NTN GNSS-free operation.

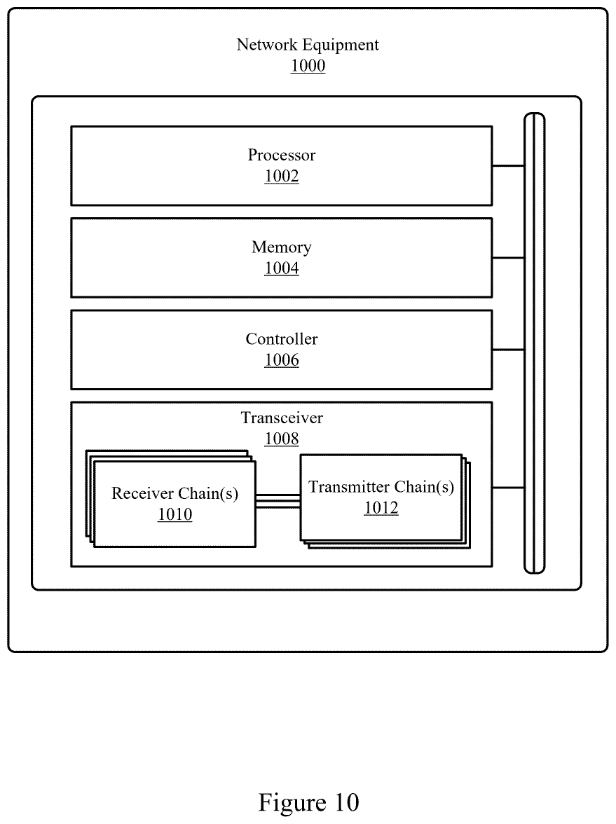

FIG. 10 illustrates an example of an NE 1000 in accordance with aspects of the present disclosure. In some examples, the NE 1000 may be an example of an NE as described with reference to FIGS. 1-7. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for transmitting positioning AD for UL time and frequency synchronization by a UE; receiving a request for the positioning AD associated with one or more non-GNSS positioning methods if GNSS connectivity is unavailable; and transmitting the positioning AD in one or more of SIB 1, SIB 19, or a SIB established for NTN GNSS-free operation.

Additionally, or alternatively, the NE 1000 may support at least one memory (e.g., the memory 1004) and at least one processor (e.g., the processor 1002) coupled with the at least one memory and configured to or operable to cause the NE to transmit positioning AD for UL time and frequency synchronization by a UE; receive a request for the positioning AD associated with one or more non-GNSS positioning methods if GNSS connectivity is unavailable; and transmit the positioning AD in one or more of SIB 1, SIB 19, or a SIB established for NTN GNSS-free operation.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., an LNA) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

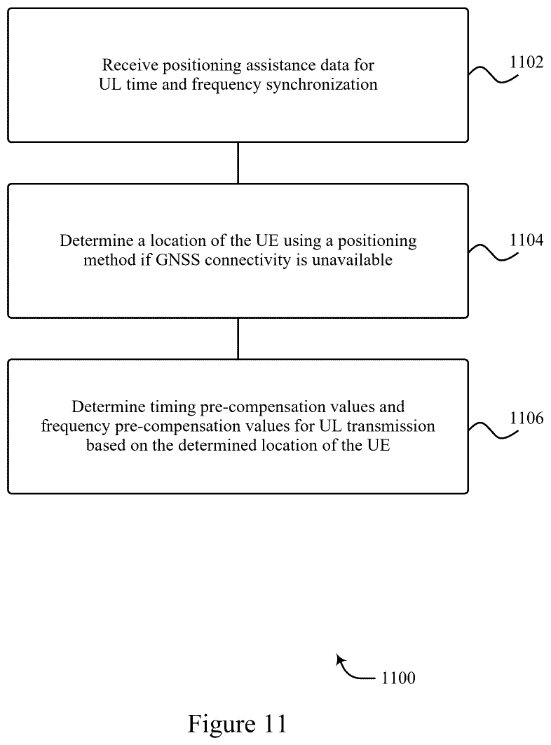

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include receiving positioning AD for UL time and frequency synchronization. The operations of 1102 may be performed in accordance with examples as described herein. In some implementations, aspects of the operations of 1102 may be performed by the UE 800 as described with reference to FIG. 8.

At 1104, the method may include determining a location of the UE using a positioning method if GNSS connectivity is unavailable. The operations of 1104 may be performed in accordance with examples as described herein. In some implementations, aspects of the operations of 1104 may be performed by the UE 800 as described with reference to FIG. 8.

At 1106, the method may include determining timing pre-compensation values and frequency pre-compensation values for UL transmission based on the determined location of the UE. The operations of 1106 may be performed in accordance with examples as described herein. In some implementations, aspects of the operations of 1106 may be performed by the UE 800 as described with reference to FIG. 8.

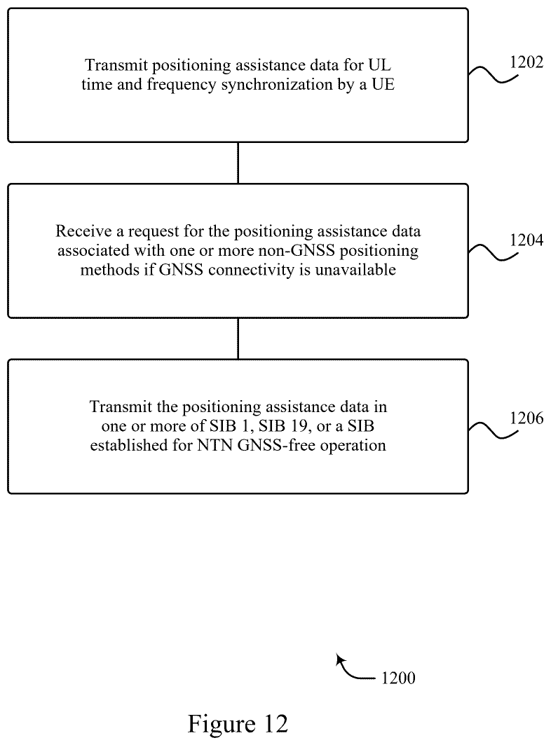

FIG. 12 illustrates a flowchart of a method 1200 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include transmitting positioning AD for UL time and frequency synchronization by a UE. The operations of 1202 may be performed in accordance with examples as described herein. In some implementations, aspects of the operations of 1202 may be performed by the NE 1000 as described with reference to FIG. 10.

At 1204, the method may include receiving a request for the positioning AD associated with one or more non-GNSS positioning methods if GNSS connectivity is unavailable. The operations of 1204 may be performed in accordance with examples as described herein. In some implementations, aspects of the operations of 1204 may be performed by the NE 1000 as described with reference to FIG. 10.

At 1206, the method may include transmitting the positioning AD in one or more of SIB 1, SIB 19, or a SIB established for NTN GNSS-free operation. The operations of 1206 may be performed in accordance with examples as described herein. In some implementations, aspects of the operations of 1206 may be performed by the NE 1000 as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive positioning assistance data (AD) for uplink (UL) time and frequency synchronization;
determine a location of the UE using a positioning method if global navigation satellite system (GNSS) connectivity is unavailable; and
determine timing pre-compensation values and frequency pre-compensation values for UL transmission based on the determined location of the UE.

2. The UE of claim 1, wherein:
the positioning method is one of one or more non-GNSS positioning methods;
the at least one processor is operable to cause the UE to:
determine that the GNSS connectivity is unavailable; and
transmit a request for the positioning AD associated with one or more of the non-GNSS positioning methods.

3. The UE of claim 2, wherein:
the positioning AD of the one or more non-GNSS positioning methods is radio access technology (RAT)-dependent positioning AD or RAT-independent positioning AD; and
the positioning AD comprises one or more of observed time difference of arrival (OTDOA) positioning AD, barometric positioning AD, terrestrial beacon system (TBS) assistance data, new radio (NR) downlink time difference of arrival (DL-TDOA) positioning AD, downlink angle of departure (DL-AoD) positioning AD, on-demand downlink positioning reference signal (DL-PRS) configurations, integrity assistance data for NR positioning methods, or sidelink (SL) positioning AD.

4. The UE of claim 3, wherein:
the positioning AD includes at least DL-PRS time-frequency information for computing the determined location of the UE; and
the DL-PRS time-frequency information comprises bandwidth, a number of physical resource blocks (PRBs), a number of symbols, a comb size, a muting pattern, a repetition configuration, a slot offset, or a resource element offset.

5. The UE of claim 2, wherein the at least one processor is operable to cause the UE to utilize one or more of long term evolution (LTE) positioning protocol (LPP) or mobile originated location request (MO-LR) signaling framework for transmission and/or reception of the positioning AD.

6. The UE of claim 2, wherein the request for the positioning AD of the one or more non-GNSS positioning methods and the determined location comprises one or more of:
a first indication of horizontal positioning accuracy, uncertainty, or confidence; or
a second indication of vertical positioning accuracy, uncertainty, or confidence.

7. The UE of claim 2, wherein the at least one processor is operable to cause the UE to transmit an on-demand request for the positioning AD associated with at least one different non-GNSS positioning method if a positioning accuracy requirement of the determined location of the UE is not met.

8. The UE of claim 1, wherein the at least one processor is operable to cause the UE to receive the positioning AD in one or more of system information block 1 (SIB 1), SIB 19, or a SIB established for non-terrestrial network (NTN) GNSS-free operation.

9. The UE of claim 1, wherein the GNSS connectivity being unavailable triggers one or more of UE-initiated positioning procedures or network (NW)-initiated positioning procedures.

10. The UE of claim 1, wherein the timing pre-compensation values include a UE-specific timing advance, and the frequency pre-compensation values include a doppler compensation or a doppler shift.

11. The UE of claim 1, wherein the positioning AD comprises information to enable the UE to derive its own location, and the positioning AD is configured for aperiodic transmission or periodic transmission.

12. A method performed by a user equipment (UE), the method comprising:
receiving positioning assistance data (AD) for uplink (UL) time and frequency synchronization;
determining a location of the UE using a positioning method if global navigation satellite system (GNSS) connectivity is unavailable; and
determining timing pre-compensation values and frequency pre-compensation values for UL transmission based on the determined location of the UE.

13. The method of claim 12, wherein the positioning method is one of one or more non-GNSS positioning methods, and the method further comprising:
determining that the GNSS connectivity is unavailable; and
transmitting a request for the positioning AD associated with one or more of the non-GNSS positioning methods.

14. The method of claim 13, wherein:
the positioning AD of the one or more non-GNSS positioning methods is radio access technology (RAT)-dependent positioning AD or RAT-independent positioning AD; and
the positioning AD comprises one or more of observed time difference of arrival (OTDOA) positioning AD, barometric positioning AD, terrestrial beacon system (TBS) assistance data, new radio (NR) downlink time difference of arrival (DL-TDOA) positioning AD, downlink angle of departure (DL-AoD) positioning AD, on-demand downlink positioning reference signal (DL-PRS) configurations, integrity assistance data for NR positioning methods, or sidelink (SL) positioning AD.

15. The method of claim 14, wherein:
the positioning AD includes at least DL-PRS time-frequency information for computing the determined location of the UE; and
the DL-PRS time-frequency information comprises bandwidth, a number of physical resource blocks (PRBs), a number of symbols, a comb size, a muting pattern, a repetition configuration, a slot offset, or a resource element offset.

16. The method of claim 13, further comprising:
utilizing one or more of long term evolution (LTE) positioning protocol (LPP) or mobile originated location request (MO-LR) signaling framework for transmission and/or reception of the positioning AD.

17. The method of claim 13, further comprising:
transmitting an on-demand request for the positioning AD associated with at least one different non-GNSS positioning method if a positioning accuracy requirement of the determined location of the UE is not met.

18. The method of claim 12, further comprising:
receiving the positioning AD in one or more of system information block 1 (SIB 1), SIB 19, or a SIB established for non-terrestrial network (NTN) GNSS-free operation.

19. A network equipment (NE) for wireless communication, comprising:
at least one memory; and
at least one processor coupled with the at least one memory and operable to cause the NE to:
transmit positioning assistance data (AD) for uplink (UL) time and frequency synchronization by a user equipment (UE);
receive a request for the positioning AD associated with one or more non-global navigation satellite system (GNSS) positioning methods if GNSS connectivity is unavailable; and
transmit the positioning AD in one or more of system information block 1 (SIB 1), SIB 19, or a SIB established for non-terrestrial network (NTN) GNSS-free operation.

20. A method performed by a network equipment (NE), the method comprising:
transmitting positioning assistance data (AD) for uplink (UL) time and frequency synchronization by a user equipment (UE);
receiving a request for the positioning AD associated with one or more non-global navigation satellite system (GNSS) positioning methods if GNSS connectivity is unavailable; and
transmitting the positioning AD in one or more of system information block 1 (SIB 1), SIB 19, or a SIB established for non-terrestrial network (NTN) GNSS-free operation.
